(19) United States
(12) Patent Application Publication
(10) Pub. No.: US 2026/0039838 A1
(43) Pub. Date: Feb. 5, 2026

(54) SYSTEM AND METHOD FOR INTRA TEMPLATE MATCHING

(71) Applicant: GUANGDONG OPPO MOBILE TELECOMMUNICATIONS CORP., LTD., Dongguan (CN)

(72) Inventors: Yue YU, Dongguan (CN); Jonathan GAN, Dongguan (CN); Haoping YU, Dongguan (CN)

(21) Appl. No.: 19/356,748

(22) Filed: Oct. 13, 2025

Related U.S. Application Data
(63) Continuation of application No. PCT/CN2024/087593, filed on Apr. 12, 2024.
(60) Provisional application No. 63/459,236, filed on Apr. 13, 2023.
(60) Provisional application No. 63/459,550, filed on Apr. 14, 2023.

(51) Int. Cl. H04N 19/159; H04N 19/117; H04N 19/132; H04N 19/176; H04N 19/593; H04N 19/70

(52) U.S. Cl. CPC H04N 19/159; H04N 19/117; H04N 19/132; H04N 19/176; H04N 19/593; H04N 19/70

(57) ABSTRACT

According to one aspect of the present disclosure, a method of decoding by a decoder is provided. The method includes: parsing, by a processor, a bitstream to decode a plurality of syntax elements associated with intra template matching prediction (intraTMP); decoding, by the processor, a first syntax element from the bitstream; determining, by the processor, whether an intraTMP mode is enabled for a current block based on the first syntax element; in response to the intraTMP mode being enabled for the current block, decoding, by the processor, a second syntax element from the bitstream; determining, by the processor, whether an intraTMP predictor for the current block is determined by an intraTMP fusion mode based on the second syntax element; and decoding, by the processor, the current block based on the intraTMP predictor.

### CROSS-REFERENCE TO RELATED APPLICATIONS

This application is a continuation of International Application No. PCT/CN2024/087593, filed on Apr. 12, 2024, which claims the benefit of priorities to U.S. Provisional Application No. 63/459,236, entitled “SYSTEMS AND METHODS FOR INTRA TEMPLATE MATCHING” and filed on Apr. 13, 2023, and to U.S. Provisional Application No. 63/459,550, entitled “SYSTEMS AND METHODS FOR INTRA TEMPLATE MATCHING” and filed on Apr. 14, 2023, all of which are incorporated by reference herein in their entireties.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, enhanced video coding model (ECM), to name a few.

### SUMMARY

According to one aspect of the present disclosure, a method of decoding by a decoder is provided. The method may include parsing, by a processor, a bitstream to decode a plurality of syntax elements associated with intra template matching prediction (intraTMP). The method may include decoding, by the processor, a first syntax element from the bitstream. The method may include determining, by the processor, whether an intraTMP mode is enabled for a current block based on the first syntax element. The method may include, in response to the intraTMP mode being enabled for the current block, decoding, by the processor, a second syntax element from the bitstream. The method may include determining, by the processor, whether an intraTMP predictor for the current block is determined by an intraTMP fusion mode based on the second syntax element. The method may include, in response to determining the intraTMP predictor is determined by an intraTMP fusion mode, decoding, by the processor, a third syntax element and a fourth syntax element from the bitstream. The method may include determining, by the processor, a set of fusion weights based on the fourth syntax element. The method may include determining, by the processor, the intraTMP predictor based on the set of fusion weights and a set of reference blocks indicated by the third syntax element. The method may include decoding, by the processor, the current block based on the intraTMP predictor.

According to another aspect of the present disclosure, a decoder is provided. The decoder may include a processor and memory storing instructions. The memory storing instructions, which when executed by the processor, may cause the processor to parse a bitstream to decode a plurality of syntax elements associated with intraTMP. The memory storing instructions, which when executed by the processor, may cause the processor to decode a first syntax element from the bitstream. The memory storing instructions, which when executed by the processor, may cause the processor to determine whether an intraTMP mode is enabled for a current block based on the first syntax element. The memory storing instructions, which when executed by the processor, may cause the processor to, in response to the intraTMP mode being enabled for the current block, decode a second syntax element from the bitstream. The memory storing instructions, which when executed by the processor, may cause the processor to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, decode a third syntax element and a fourth syntax element from the bitstream. The memory storing instructions, which when executed by the processor, may cause the processor to determine a set of fusion weights based on the fourth syntax element. The memory storing instructions, which when executed by the processor, may cause the processor to determine the intraTMP predictor based on the set of fusion weights and a set of reference blocks indicated by the third syntax element. The memory storing instructions, which when executed by the processor, may cause the processor to decode the current block based on the intraTMP predictor.

According to a further aspect of the present disclosure, a non-transitory computer-readable medium storing instructions for a decoder is provided. The memory storing instructions, which when executed by the processor of the decoder, may cause the processor of the decoder to parse a bitstream to decode a plurality of syntax elements associated with intraTMP. The memory storing instructions, which when executed by the processor of the decoder, may cause the processor of the decoder to decode a first syntax element from the bitstream. The memory storing instructions, which when executed by the processor of the decoder, may cause the processor of the decoder to determine whether an intraTMP mode is enabled for a current block based on the first syntax element. The memory storing instructions, which when executed by the processor, may cause the processor to, in response to the intraTMP mode being enabled for the current block, decode a second syntax element from the bitstream. The memory storing instructions, which when executed by the processor of the decoder, may cause the processor of the decoder to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, decode a third syntax element and a fourth syntax element from the bitstream. The memory storing instructions, which when executed by the processor of the decoder, may cause the processor of the decoder to determine a set of fusion weights based on the fourth syntax element. The memory storing instructions, which when executed by the processor of the decoder, may cause the processor of the decoder to determine the intraTMP predictor based on the set of fusion weights and a set of reference blocks indicated by the third syntax element. The memory storing instructions, which when executed by the processor of the decoder, may cause the processor of the decoder to decode the current block based on the intraTMP predictor.

According to yet another aspect of the present disclosure, a method of encoding by an encoder is provided. The method may include enabling, by a processor, intraTMP to encode a current block. The method may include encoding, by the processor, a first syntax element to a bitstream. The method may include determining, by the processor, whether an intraTMP mode is enabled for a current block based on the first syntax element. The method may include, in response to the intraTMP mode being enabled for the current block, encoding, by the processor, a second syntax element to the bitstream. The method may include determining, by the processor, whether an intraTMP predictor for the current block is determined by an intraTMP fusion mode based on the second syntax element. The method may include, in response to determining the intraTMP predictor is determined by an intraTMP fusion mode, encoding, by the processor, a third syntax element and a fourth syntax element to the bitstream. The method may include determining, by the processor, a set of fusion weights based on the fourth syntax element. The method may include determining, by the processor, the intraTMP predictor based on the set of fusion weights and a set of reference blocks indicated by the third syntax element. The method may include encoding, by the processor, the current block based on the intraTMP predictor.

According to still another aspect of the present disclosure, an encoder is provided. The encoder may include a processor and memory storing instructions. The memory storing instructions, which when executed by the processor, may cause the processor to enable intraTMP to encode a current block. The memory storing instructions, which when executed by the processor, may cause the processor to encode a first syntax element to a bitstream. The memory storing instructions, which when executed by the processor, may cause the processor to determine whether an intraTMP mode is enabled for a current block based on the first syntax element. The memory storing instructions, which when executed by the processor, may cause the processor to, in response to the intraTMP mode being enabled for the current block, encode a second syntax element to the bitstream. The memory storing instructions, which when executed by the processor, may cause the processor to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, encode a third syntax element and a fourth syntax element to the bitstream. The memory storing instructions, which when executed by the processor, may cause the processor to determine a set of fusion weights based on the fourth syntax element. The memory storing instructions, which when executed by the processor, may cause the processor to determine the intraTMP predictor based on the set of fusion weights and a set of reference blocks indicated by the third syntax element. The memory storing instructions, which when executed by the processor, may cause the processor to encode the current block based on the intraTMP predictor.

According to still a further aspect of the present disclosure, a non-transitory computer-readable medium storing instructions for an encoder is provided. The instructions, which when executed by the processor of the encoder, may cause the processor of the encoder to enable intraTMP to encode a current block. The instructions, which when executed by the processor of the encoder, may cause the processor of the encoder to encode a first syntax element to a bitstream. The instructions, which when executed by the processor of the encoder, may cause the processor of the encoder to determine whether an intraTMP mode is enabled for a current block based on the first syntax element. The memory storing instructions, which when executed by the processor, may cause the processor to, in response to the intraTMP mode being enabled for the current block, encode a second syntax element to the bitstream. The instructions, which when executed by the processor of the encoder, may cause the processor of the encoder to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, encode a third syntax element and a fourth syntax element to the bitstream. The instructions, which when executed by the processor of the encoder, may cause the processor of the encoder to determine a set of fusion weights based on the fourth syntax element. The instructions, which when executed by the processor of the encoder, may cause the processor of the encoder to determine the intraTMP predictor based on the set of fusion weights and a set of reference blocks indicated by the third syntax element. The instructions, which when executed by the processor of the encoder, may cause the processor of the encoder to encode the current block based on the intraTMP predictor.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates an exemplary picture divided into coding tree units (CTUs), according to some embodiments of the present disclosure.

FIG. 6 illustrates an exemplary CTU divided into coding units (CUs), according to some embodiments of the present disclosure.

FIG. 7 illustrates a schematic visualization of a current CU block and spatially adjacent and non-adjacent reconstructed samples to the current block, according to some embodiments of the present disclosure.

FIG. 8 illustrates a schematic visualization of the angular modes of VVC, according to some embodiments of the present disclosure.

FIG. 9A illustrates a schematic visualization of an intra template matching prediction (intraTMP) search area, according to some embodiments of the present disclosure.

FIG. 9B illustrates a schematic visualization of an intraTMP extended search area, according to some embodiments of the present disclosure.

FIG. 10 illustrates a spatial component of an intraTMP filter, according to some embodiments of the present disclosure.

FIG. 11 illustrates a reference area used to derive the filter coefficients for intraTMP, according to some embodiments of the present disclosure.

FIG. 12 illustrates a diagram of adjacent half-pel positions for intraTMP, according to some embodiments of the present disclosure.

FIG. 13 illustrates a diagram of various template shapes for intraTMP, according to some embodiments of the present disclosure.

FIG. 14 illustrates a diagram of fractional block vector positions for intraTMP, according to some embodiments of the present disclosure.

FIGS. 15A-15D illustrate a flowchart of an exemplary method of video decoding, according to some embodiments of the present disclosure.

FIGS. 16A-16D illustrate a flowchart of an exemplary method of video encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

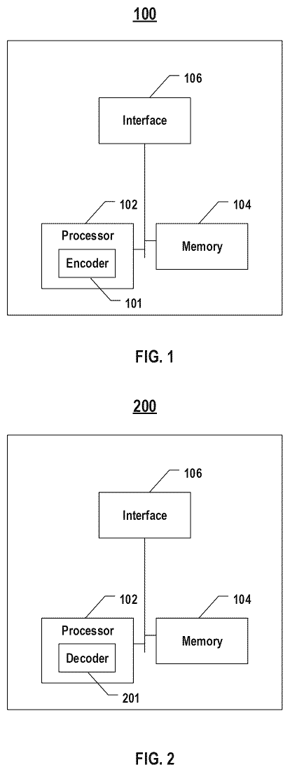

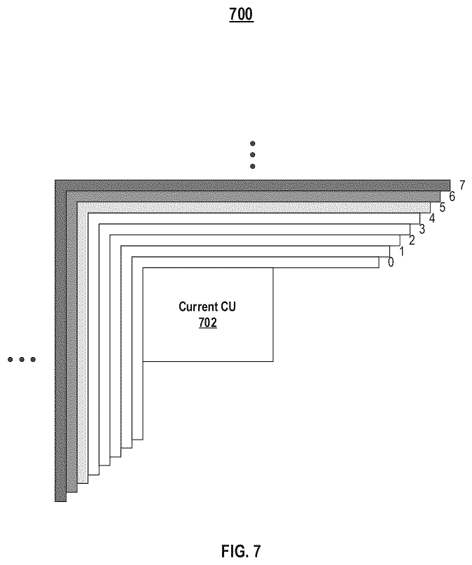

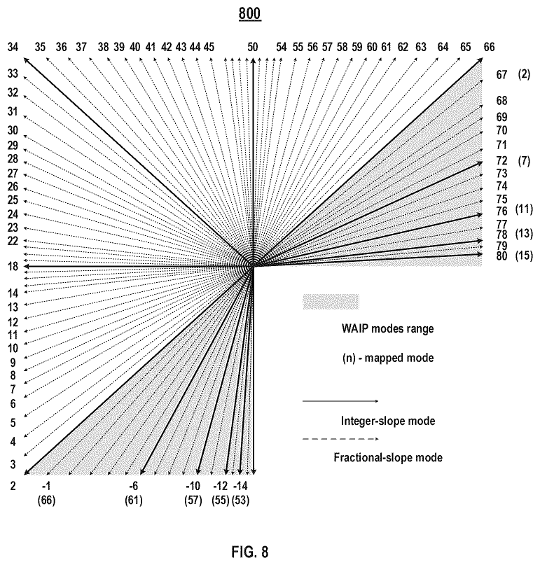

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 7 and 8, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 7 and 8, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 7 and 8, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 7 and 8, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail.

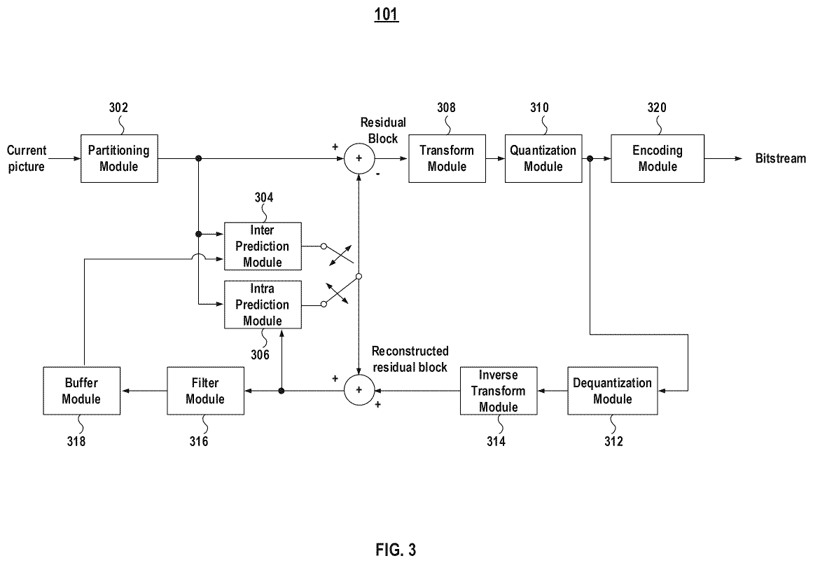

FIG. 3 illustrates a detailed block diagram of exemplary encoder 101 in encoding system 100 in FIG. 1, according to some embodiments of the present disclosure. As shown in FIG. 3, encoder 101 may include a partitioning module 302, an inter prediction module 304, an intra prediction module 306, a transform module 308, a quantization module 310, a dequantization module 312, an inverse transform module 314, a filter module 316, a buffer module 318, and an encoding module 320. It is understood that each of the elements shown in FIG. 3 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101.

Partitioning module 302 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 302 may partition a picture into a combination of a plurality of coding units, prediction units, and transform units, and encode a picture by selecting a combination of a coding unit, a prediction unit, and a transform unit based on a predetermined criterion (e.g., a cost function).

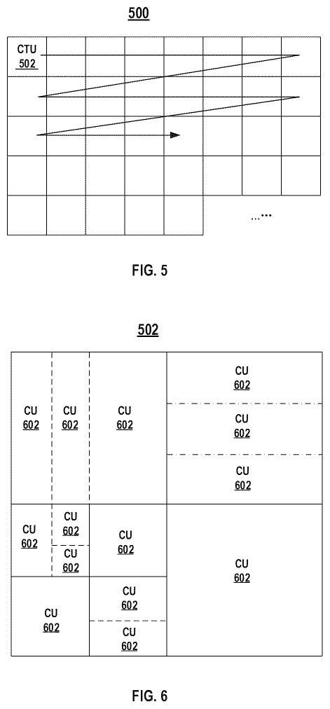

Similar to H.265/HEVC, H.266/VVC is a block-based hybrid spatial and temporal predictive coding scheme. As shown in FIG. 5, during encoding, an input picture 500 is first divided into square blocks—CTUs 502, by partitioning module 302. For example, CTUs 502 can be blocks of 128×128 pixels. As shown in FIG. 6, each CTU 502 in input picture 500 can be partitioned by partitioning module 302 into one or more CUs 602, which can be used for prediction and transformation. Unlike H.265/HEVC, in H.266/VVC, CUs 602 can be rectangular or square, and can be coded without further partitioning into prediction units or transform units. For example, as shown in FIG. 6, the partition of CTU 502 into CUs 602 may include quadtree splitting (indicated in solid lines), binary tree splitting (indicated in dashed lines), and ternary splitting (indicated in dash-dotted lines). Each CU 602 can be as large as its root CTU 502 or be subdivisions of root CTU 502 as small as 4×4 blocks, according to some embodiments.

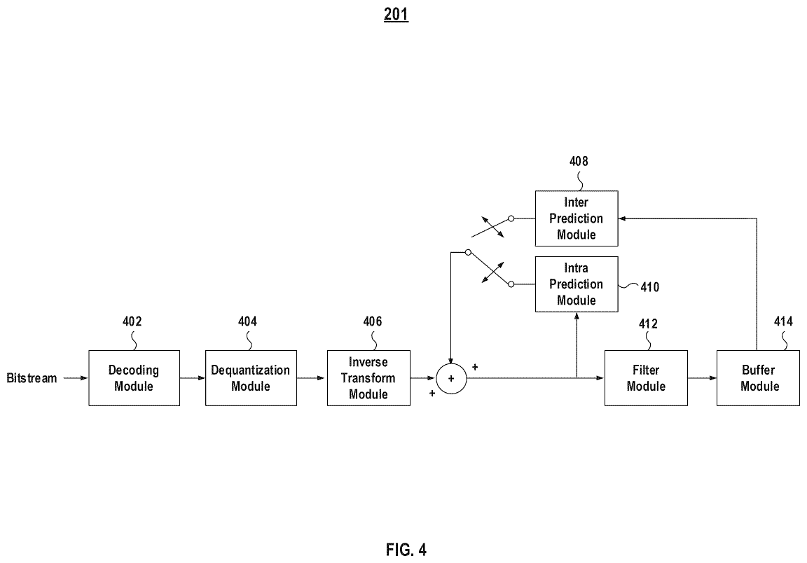

Referring to FIG. 4, inter prediction module 304 may be configured to perform inter prediction on a prediction unit, and intra prediction module 306 may be configured to perform intra prediction on the prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a prediction unit, and prediction may be performed in a transform unit. Residual coefficients in a residual block between the generated prediction block and the original block may be input into transform module 308. In addition, prediction mode information, motion vector information, and the like used for prediction may be encoded by encoding module 320 together with the residual coefficients or quantization levels into the bitstream. It is understood that in certain encoding modes, an original block may be encoded as it is without generating a prediction block through prediction module 304 or 306. It is also understood that in certain encoding modes, prediction, transform, and/or quantization may be skipped as well.

In some embodiments, inter prediction module 304 may predict a prediction unit based on information on at least one picture among pictures before or after the current picture, and in some cases, it may predict a prediction unit based on information on a partial area that has been encoded in the current picture. Inter prediction module 304 may include sub-modules, such as a reference picture interpolation module, a motion prediction module, and a motion compensation module (not shown). For example, the reference picture interpolation module may receive reference picture information from buffer module 318 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 3, in some embodiments, intra prediction module 306 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. If the size of the prediction unit is the same as the size of the transform unit when intra prediction is performed, the intra prediction may be performed for the prediction unit based on pixels on the left side, pixels on the top-left side, and pixels on the top of the prediction unit. However, if the size of the prediction unit is different from the size of the transform unit when the intra prediction is performed, the intra prediction may be performed using a reference pixel based on the transform unit.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit are the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 3, a residual block including a prediction unit that has performed prediction based on the prediction unit generated by prediction module 304 or 306 and residual coefficient information (also referred to herein as the “residual”), which is a difference value of the prediction unit with the original block, may be generated. The generated residual block may be input into transform module 308. Additional details of residuals and transforms for video coding will now be provided.

In hybrid video coding systems, redundancy in the video signal is first exploited by applying inter or intra prediction tools for each CU. The difference between the original samples of a CU and the prediction block for that CU is commonly referred to as the residual. Even after prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

For example, transform module 308 may transform the residual using an integerized version of the two-dimensional discrete cosine transform (DCT), which may be applied separably in the horizontal and vertical directions. For an M×N block of residual samples (where M is the width of the block and N is the height of the block), transform module 308 may obtain transform coefficients by applying an M×M DCT to each row, resulting in intermediate transform coefficients, and then applying an N×N DCT to each column of intermediate transform coefficients.

For intra-coded CUs (also referred to herein as “intra CUs”), spatial neighboring reconstructed samples are used to predict the current block, and the intra prediction mode is signaled once for the entire CU. Each CU consists of one or more collocated coding blocks (CBs) corresponding to the color components of the video sequence. For example, consumer video typically takes the 4:2:0 chroma format, in which case each CU consists of a luma CB and two chroma CBs with one-quarter of the samples of the luma CB. Intra prediction and transform coding are performed at the prediction block (PB) and transform block (TB) levels, respectively. Each CB consists of a single TB, except in the cases of Intra Subpartition (ISP) mode and implicit splitting. For luma CBs, the maximum side length of a TB is 64, and the minimum side length is 4. In addition, luma TBs are further specified as W×H rectangular blocks of width W and height H, where W, H E {4, 8, 16, 32, 64}. For chroma CBs, the maximum TB side length is 32, and chroma TBs are rectangular W×H blocks of width W and height H. Here, W, H∈{2, 4, 8, 16, 32}, but blocks of shapes 2×H and 4×2 are excluded in order to address memory architecture and throughput requirements.

FIG. 7 illustrates a schematic visualization 700 of a current CU block 702 and spatially adjacent and non-adjacent reconstructed samples to the current block, according to some aspects of the present disclosure. In FIG. 7, the numbers 0, 1, 2, . . . indicate the pixel-line index in relation to current CU block 702.

In VVC, the intra prediction samples for the current block are generated using reference samples that are obtained from reconstructed samples of neighboring blocks. For a W×H block, the reference samples are spatially adjacent to the current block, consisting of the vertical line of 2·H reconstructed samples to the left of the block and extending downwards, the top left reconstructed sample, and the horizontal line of 2·W reconstructed samples above the current block and extending to the right. This “L” shaped set of samples may be referred to in this disclosure as a “reference line.” The reference line directly adjacent to current CU block 702 is shown as the line with index 0 in FIG. 7.

Similar to AVC and HEVC, VVC also supports angular intra prediction modes. Angular intra prediction is a directional intra prediction method. In comparison to HEVC, the angular intra prediction of VVC was modified by increasing the prediction accuracy and by an adaptation to the new partitioning framework. The former was realized by enlarging the number of angular prediction directions and by more accurate interpolation filters, while the latter was achieved by introducing wide-angular intra prediction modes. In VVC, the number of directional modes available for a given block is increased to 65 directions from the 33 HEVC directions. The angular modes 800 of VVC are depicted in FIG. 8.

The directions having even indices between 2 and 66 are equivalent to the directions of the angular modes supported in HEVC. For blocks of square shape, an equal number of angular modes is assigned to the top and left side of a block. On the other hand, intra blocks of rectangular shape, which are not present in HEVC, are a central part of VVC's partitioning scheme with additional intra prediction directions assigned to the longer side of a block. The additional modes allocated along a longer side are called Wide-Angle Intra Prediction (WAIP) modes, since they correspond to prediction directions with angles greater than 45° relative to the horizontal or vertical mode. A WAIP mode for a given mode index is defined by mapping the original directional mode to a mode that has the opposite direction with an index offset equal to one, as shown in FIG. 8. For a given rectangular block, the aspect ratio, i.e., the ratio of width to height, is used to determine which angular modes are to be replaced by the corresponding wide-angular modes.

For square-shaped blocks in VVC, each pair of predicted samples that are horizontally or vertically adjacent are predicted from a pair of adjacent reference samples. To the contrary, WAIP extends the angular range of directional prediction beyond 45°, and therefore, for a coding block predicted with a WAIP mode, adjacent predicted samples may be predicted from non-adjacent reference samples.

In addition to the directly adjacent line of neighboring samples, one of the two non-adjacent reference lines (line 1 and line 2) that are depicted in FIG. 7 may include the input samples for intra prediction in VVC. For ECM, more non-adjacent reference lines may be used. The use of adjacent and non-adjacent reference samples is referred to as multiple reference line (MRL) prediction.

The intra modes that can be used for MRL are the DC mode and the angular prediction modes. However, for a given block, not all of these modes can be combined with MRL. The MRL mode is always coupled with a mode in the Most Probable Mode (MPM) list in VVC. This coupling means that if non-adjacent reference lines are used, the intra prediction mode is one of the MPMs. Such a design of an MPM-based MRL prediction mode is motivated by the observation that non-adjacent reference lines are mainly beneficial for texture patterns with sharp and strongly directed edges. In these cases, MPMs are much more frequently selected since there is typically a strong correlation between the texture patterns of the neighboring and the current blocks. On the other hand, choosing a non-MPM for intra prediction is an indication that edges are not consistently distributed in neighboring blocks, and thus, the MRL prediction mode is expected to be less useful in this case. In addition, it has been observed that MRL does not provide additional coding gain when the intra prediction mode is the Planar mode, since this mode is typically used for smooth areas. Consequently, MRL excludes the Planar mode, which is always one of the MPMs. The angular or DC prediction process in MRL is very similar to the case of a directly adjacent reference line. However, for angular modes with a non-integer slope, a DCT-based interpolation filter (DCTIF) is always used. This design choice is both evidenced by experimental results and aligned with the empirical observation that MRL is mostly beneficial for sharp and strongly directed edges where the DCTIF is more appropriate since it retains more high frequencies than some other filters.

From a hardware design perspective, applying multiple reference lines as proposed in the initial methods requires extra cost of line buffers that are used for holding the additional reference lines. In typical hardware designs, line buffers are part of the on-chip memory architecture for image and video coding, and it is of great importance to minimize their on-chip area. To address this issue, MRL is disabled and not signaled for the coding units that are attached to the top boundary of the CTU. In this way, the extra buffers for holding non-adjacent reference lines are bounded by 128, which is the width of the largest unit size.

In some known approaches, an intra prediction fusion method was proposed to improve the accuracy of intra prediction. More specifically, if the current block is a luma block, and it is coded with a non-integer slope angular mode and not in the ISP mode, and the block size (width*height) is greater than 16, two prediction blocks generated from two different reference lines will be “fused,” where the prediction fusion is calculated as a weighted summation of the two prediction blocks. More specifically, a first reference line at index i (lineᵢ) is specified with the current methods of signaling in the bitstream, and the prediction block generated from this reference line using the selected intra prediction mode is denoted as p(lineᵢ), where p(⋅) represents the operation of generating a prediction block from a reference line with a given intra prediction mode. In the known approach, the reference line lineᵢ₊₁ is implicitly selected as the second reference line. That is, the second reference line is one index position further away from the current block relative to the first reference line. Similarly, the prediction block generated from the second reference line is denoted as p(lineᵢ₊₁). The weighted sum of the two prediction blocks is obtained as follows and serves as the predictor for the current block according to equation (1).

$${p}_{fusion} = {w}_{0} * p ( {line}_{i} ) + {w}_{1} * p ( {line}_{i + 1} ) , \qquad ( 1 )$$

where p_{fusion} represents the fused prediction, w₀ and w₁ are two weighting factors, and they are set as ¾ and ¼ in the experiment, respectively.

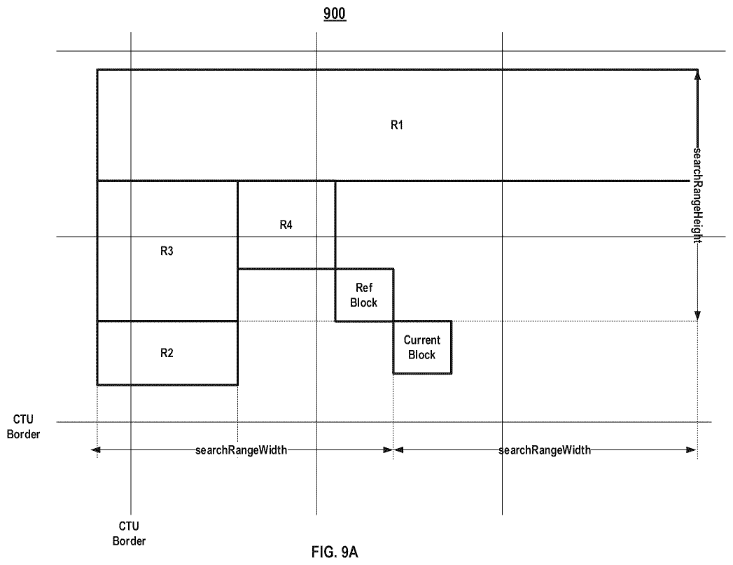

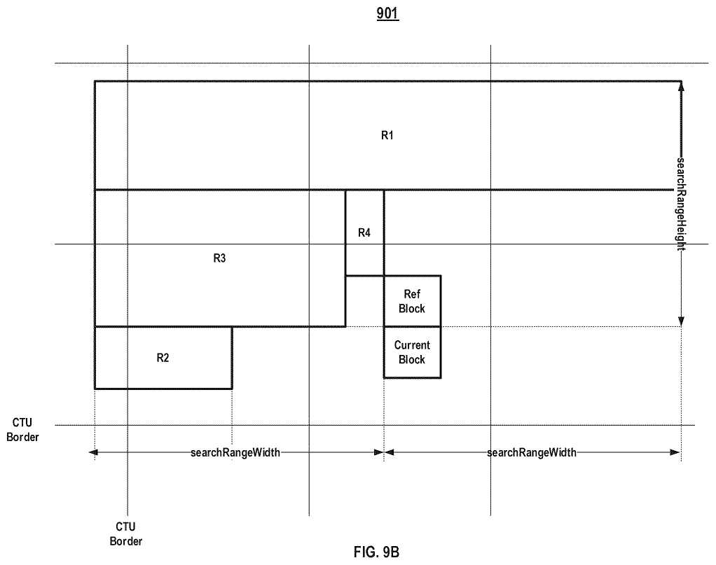

FIG. 9A illustrates a schematic visualization of an intraTMP search area 900, according to some embodiments of the present disclosure.

Intra template matching prediction (intraTMP) is a special intra prediction mode that copies the best prediction block from the reconstructed part of the current frame, whose L-shaped or other shaped template matches the current template. Unlike intra block copy (IBC) a block vector is not signaled in the bitstream. For a predefined search range, encoder 101 searches for the most similar template to the current template in a reconstructed part of the current frame and uses the corresponding block as a prediction block. Encoder 101 then signals the usage of this mode, and the same prediction operation is performed by decoder 201.

The prediction signal is generated by matching the predefined causal neighbor of the current block with another block in a predefined search areas consisting of current CTU, top-left CTUs, above CTUs, and left CTU, as shown in FIG. 9A.

The sum of absolute differences (SAD) or the sum of absolute transformed differences (SATD), or by comparing hashes between templates, is used as a cost function. Within each region, decoder 201 searches for the template that has the least cost with respect to the current one and uses its corresponding block as a prediction block.

The dimensions of all regions (searchRangeWidth, searchRangeHeight) are set proportional to the block dimension (BlkW, BlkH) to have a fixed number of SAD comparisons per pixel. For instance, searchRangeWidth=a*BlkW and searchRangeHeight=a*BlkH, where ‘a’ is a constant that controls the gain/complexity trade-off In practice, ‘a’ is equal to 5 in the ECM-7.0 test software.

To speed up the template matching process, the search region is initially traversed in increments of 2 pixels at a time. This is also referred to as a search sub-sampling factor of 2. This leads to a 4-fold reduction in the template matching search complexity. After finding the best match from the initial search, a refinement process is performed. The refinement is done via a second template matching search around the best match with a reduced range. The reduced range is defined as min(BlkW, BlkH)/2 where BlkW and BlkH are the width and height of the current block respectively.

The intra template matching prediction tool is enabled for CUs with sizes less than or equal to 64 in width and height. This maximum CU size for intraTMP is configurable. The intraTMP mode is signaled at CU level through a dedicated flag when decoder-side intra mode derivation DIMD is not used for the current CU.

FIG. 9B illustrates a schematic visualization of an intraTMP extended search area 901, according to some embodiments of the present disclosure.

The original intraTMP method implicitly selects only one block vector by searching for the smallest template matching cost. However, for camera-captured content, template matching cannot be relied on alone to find a good predictor. There are usually several blocks similar to the current block, and their template matching costs are comparable. The BV with the smallest template matching cost may not be the best predictor for the current block. To further improve the coding performance, a multiple candidate method may be used for intraTMP. In the multiple-candidate method, a prediction candidate list is constructed with candidate BVs arranged in ascending order of their corresponding template matching costs. This candidate list is constructed by both encoder 101 and decoder 201. An index is signaled in the bit-stream to indicate which candidate BV is selected for the current block. This method exploits template matching to select a shortlist of promising candidates out of a huge number of possible BVs, and then allows encoder 101 (which can check the current block's true coding cost for each of these candidates) to make a rate-distortion optimised (RDO) decision from the shortlist. The candidate list construction has relatively low complexity compared to encoder RDO.

The prosed syntax change(s) are shown below in Table 1.

TABLE 1

...
intra_tmp_flag
if(intra_tmp_flag) {
intra_tmp_idx
}
...

In Table 1, intra_tmp_flag equal to 1 means that the current block uses intraTMP, and intra_tmp_idx further indicates which BV in the candidate BV list is used to identify the prediction block.

To build the candidate list, a sparse search and a refinement search may be used. In the sparse search, the sub-sampling factor is set to 3, and the 30 BVs with the smallest SAD costs are kept after the sparse search. In the refinement search, a 3×3 local search around each of the 30 BVs is checked. The 15 BVs with the smallest SAD costs after the refinement search are selected to form the candidate list.

In the intraTMP fusion method, multiple intraTMP predictor blocks are derived first and then fused to produce a better overall predictor. These predictor blocks may also be referred to as “matched blocks,” “fusion blocks,” or “predictors.” The intraTMP fusion method is asserted to be beneficial for camera-captured content. In summary, the intraTMP fusion method may include the following four operations.

In a first operation, the intraTMP fusion method may generate multiple candidate predictors during the intraTMP search. For instance, a sparse intraTMP search process is first performed with a search sub-sampling factor of 3. After the sparse search, a candidate list is generated with the 30 candidate BVs having the smallest template SAD. Around each candidate BV, a full pixel refinement search is performed within a small region. The refinement region is a 3×3 area around each of the 30 candidate BVs. Finally, the 3 best candidate BVs, as measured by template SAD across all refinement regions, are selected. The blocks pointed to by each of these candidate BVs are selected as candidate predictor blocks for intraTMP fusion.

In a second operation, the intraTMP fusion method may select candidate predictors used for fusion. For instance, for each of the 3 candidate predictor blocks, a threshold is used to judge whether it should be used for fusion, as shown below in equation (2).

$$Threshold = {SAD}_{1} << 1 , \qquad ( 2 )$$

where SAD₁ is the smallest template SAD of the three candidate predictor blocks. Candidate predictor blocks with SAD<=Threshold are selected for fusion. This also determines the number of candidate predictor blocks selected for fusion.

In a third operation, the intraTMP fusion method may calculate a weighting factor for each predictor block selected for fusion. For instance, once predictor blocks to be fused are determined, they are fused with weights. Two methods of determining these fusion weights may be used, in accordance with the present disclosure.

In the first method of the third operation, fusion weights wᵢ are calculated by their SAD. The fusion weights wᵢ are calculated according to equations (3) and (4).

$$sum = {\sum }_{i = 1}^{n} S A {D}_{i} , and \qquad ( 3 )$$

$${w}_{i} = \frac{sum - {SAD}_{i}}{( n - 1 ) * s u m} . \qquad ( 4 )$$

To simplify the implementation, the division operations are replaced by an integer look-up table (LUT). In the second method of the third operation, fusion weights with fixed values are used to further reduce the complexity. The weights are set as

$$\{ {w}_{1} , {w}_{2} \} = \{ \frac{1}{2} , \frac{1}{2} \} or \{ {w}_{1} , {w}_{2} , {w}_{3} \} = \{ \frac{22}{64} , \frac{21}{64} , \frac{21}{64} \} .$$

In a fourth operation, the intraTMP fusion method may determine the final fused predictor according to equation (5).

$${P}_{fusion} = {\sum }_{i = 1}^{n} {w}_{i} {p}_{i} , \qquad ( 5 )$$

where pᵢ is the i^{th} predictor block, and n is the number of predictor blocks selected for fusion.

Still referring to the fourth operation, in a special case when only one predictor block remains after the second operation, the final predictor is calculated according to equation (6).

$${p}_{f u s i o n} = {w}_{1} {p}_{T M P} + {w}_{2} {p}_{intra} , \qquad ( 6 )$$

where p_{TMP} is the single predictor block and pᵢₙₜᵣₐ is the intra predictor derived by the Planar mode. In this special case, the weights are set as w₁=⅞ and w₂=⅛.

A CU level flag may be added to the bitstream to signal whether an intraTMP CU is predicted by the proposed intraTMP fusion method or the original intraTMP method.

For small blocks, the search range may be too small, so it is unlikely to find a good match. An enlarged search area was proposed for small blocks as follows, e.g., searchRangeWidth=max(a*BlkW, minSearchRange) and searchRangeHight=max(a*BlkH, minSearchRange), where minSearchRange is set as 128.

In addition, some left and above areas of the current block are not searched in the original intraTMP when these areas are close to the current block. It is proposed to search those areas as shown in FIG. 9B.

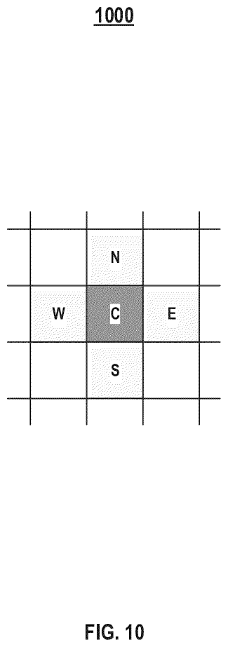

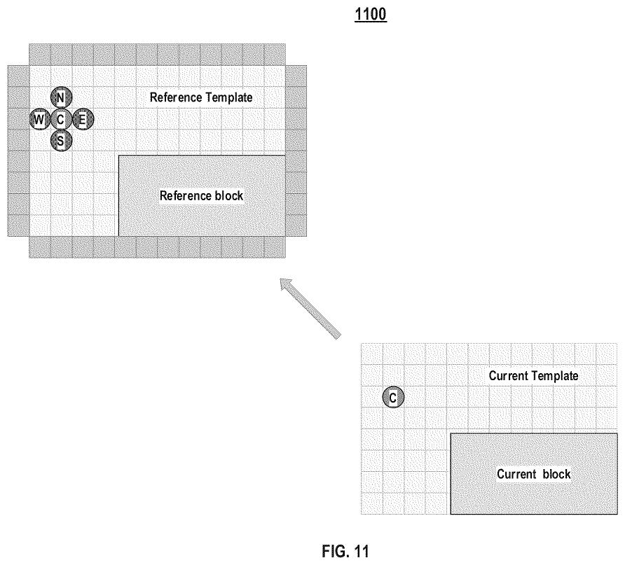

FIG. 10 illustrates a spatial component of an intraTMP filter 1000, according to some embodiments of the present disclosure.

Referring to FIG. 10, the selected block by intraTMP may be further filtered to provide a better prediction. A 6-tap filtering process was proposed to serve this purpose, which comprises a 5-tap plus sign shape spatial component and a bias term. The input to the spatial 5-tap component of the filter consists of a center (C) sample in the reference block, which is at corresponding locations with the sample in the current block to be predicted and its above/north (N), below/south (S), left/west (W) and right/east (E) neighbors.

FIG. 11 illustrates a reference area 1100 used to derive the filter coefficients for intraTMP, according to some embodiments of the present disclosure.

Referring to FIG. 11, the bias term B represents a scalar offset between the input and output and is set to the middle luma value (512 for 10-bit content). The output of the filter is calculated according to equation (7).

$$predLumaVal = c 0 C + c 1 N + c 2 S + c 3 E + c 4 W + c 5 B . \qquad ( 7 )$$

The filter coefficients ci may be calculated by minimising the mean-square error (MSE) between the filtered reference template and current template 1, as shown in FIG. 11. Extended area shown in dark grey supports the “side samples” of the plus shaped spatial filter. When not available, the pixels in the extended area may be obtained by boundary padding with or without neighboring BV information.

The MSE minimization is performed by calculating an autocorrelation matrix between the reference template input and the current template output. The autocorrelation matrix is LDL decomposed (where L is a lower unit triangular (unitriangular) matrix, and D is a diagonal matrix), and the final filter coefficients are calculated using back-substitution.

The usage of the filtered intraTMP mode is signaled by a coded CU-level flag. The filtered intraTMP is considered a sub-mode of intraTMP. That is, the intraTMP filtered flag is only signaled if the intraTMP flag is true.

Furthermore, the filtered intraTMP may be chosen from a list of candidate reference blocks to be filtered. The candidate list is constructed based on the lowest SAD costs of unfiltered templates. Different filter parameters are calculated for each candidate in the list, and the best performing one, in terms of template matching cost with the filtering, is selected and used as the final candidate. The final prediction of the block is then generated by applying the derived filter for the best candidate.

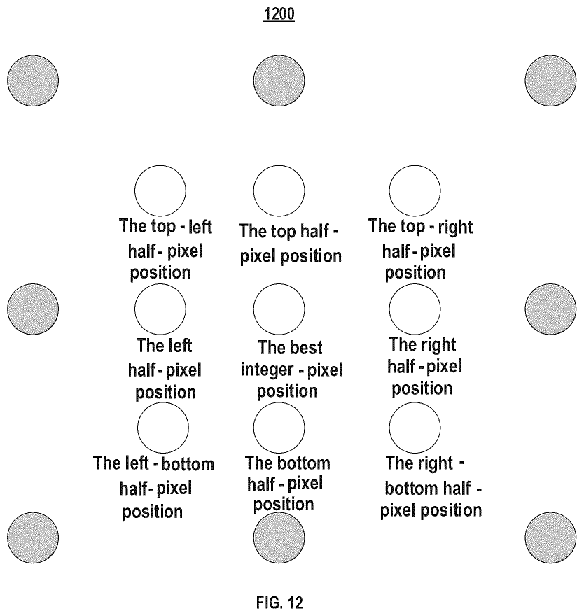

FIG. 12 illustrates a diagram of adjacent half-pel positions 1200 in 8 directions, according to some embodiments of the present disclosure.

Referring to FIG. 12, a method of intraTMP with half-pel precision was proposed to provide a better prediction. More specifically, 8 adjacent half-pel positions around the integer-pel position in 8 directions, as shown in FIG. 12 are added, and the proposed method selects one of the 9 positions (1 integer-pel position+8 half-pel positions) by encoder rate distortion optimisation (RDO).

If intraTMP mode is selected for the current block, a flag is further signaled to indicate whether to use integer-pel or half-pel precision. When using half-pel precision, an index is further signaled to indicate the direction of the half-pel position. A 4-tap DCT-IF interpolation filter, [−5, 37, 37, −5], is used for half-pel interpolation in fractional intraTMP.

A spatial combined inter- and intra-prediction (CIIP) mode, inspired by the “combination of intra and inter prediction” CIIP mode, was proposed as a new intra prediction mode. When spatial CIP mode is selected, the predictor block is generated by combining the intraTMP predictor and an intra prediction derived by using a template-based intra mode derivation (TIMD). The combination is weighted with predefined weights. Spatial CIP may be treated as a special case of intraTMP fusion.

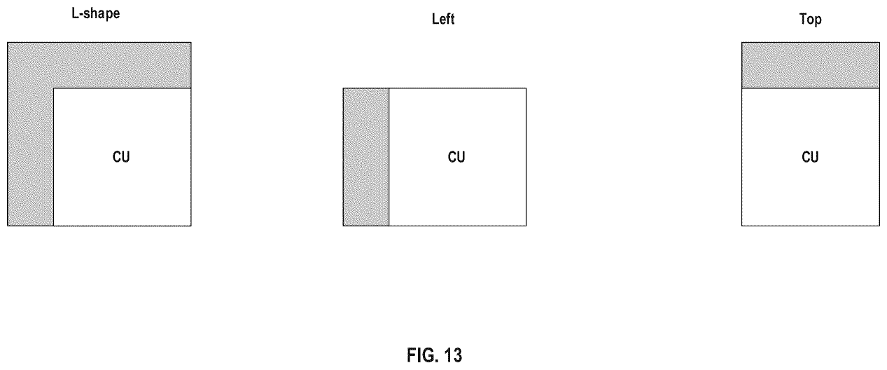

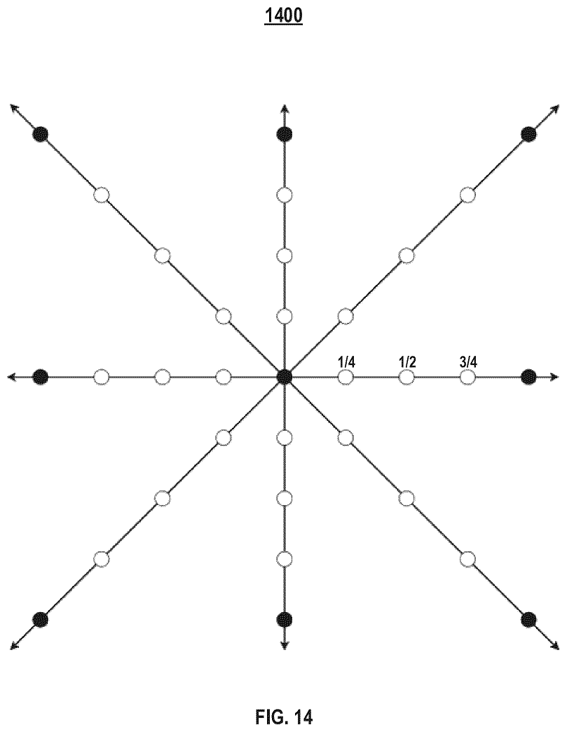

FIG. 13 illustrates a diagram of various template shapes for intraTMP, according to some embodiments of the present disclosure.

Referring to FIG. 13, two more template shapes (e.g., left template and above template) are proposed for intraTMP. Left and above templates are treated as two additional intraTMP modes. In addition, the two best candidates found by using L-shape templates are saved and fused together linearly as follows to generate a fused prediction, according to equation (8).

$${P}_{( x , y )} = \frac{( {cost}_{1} * {P}_{0 ( x , y )} + {cost}_{0} * {P}_{1 ( x , y )} )}{( cos {t}_{0} + c o s {t}_{1} )} , \qquad ( 8 )$$

where P_{(x,y)} is the fused prediction, P_{0(x,y)} and P_{1(x,y)} are the best and the second best L-shape candidate predictors, and cost₀ and cost₁ are the template costs of the two L-shape candidates obtained from the template matching process.

To signal the new modes, if intraTMP is used in the current CU, two flags are further signaled to indicate whether the L-shape template with fusion, left, or above templates are applied, as detailed below in Table 2.

TABLE 2
intraTMP mode signaling

| IntraTMP modes | Signaling |
|---|---|
| L-shape | 00 |
| L-shape with fusion | 01 |
| Left template | 10 |
| Above template | 11 |

While the intraTMP methods described above provide coding gain individually, their combination is not straightforward. Enabling and signaling the intraTMP methods described above together without restriction may incur excessive amounts of signaling overhead without providing enough improvement in prediction to justify the bits spent on signaling. To overcome these and other challenges, the present disclosure describes a combination with an efficient signaling scheme that provides cumulative coding gain from the combined intraTMP methods.

For instance, in some implementations, the present disclosure proposes that the intraTMP coding tool may be signaled by syntax elements summarised as follows:

```
intra_tmp_flag
if ( intra_tmp_flag ){
  intra_tmp_fusion_flag
  if ( intra_tmp_fusion_flag ) {
    intra_tmp_fusion_idx
    intra_tmp_fusion_weight_type
  }
  else {
    intra_tmp_idx
    intra_tmp_filter_flag
    if ( !intra_tmp_filter_flag ) {
      intra_tmp_sub_pel_flag
      if ( intra_tmp_sub_pel_flag ) {
        intra_tmp_sub_pel_direction_idx
        intra_tmp_sub_pel_phase_idx
      }
    }
  }
}
```

Firstly, an intraTMP flag (intra_tmp_flag) may be signaled to indicate if the current block is predicted by intraTMP. This syntax element may be decoded from the bitstream, or it may have an inferred value. For example, the intraTMP flag may have an inferred value of 0 if the intraTMP tool is disabled at a higher syntax level, e.g., such as in a sequence parameter set (SPS).

If the current block is predicted by intraTMP, then an intraTMP fusion flag (intra_tmp_fusion_flag) may be signaled to indicate if the intraTMP predictor is determined by fusing multiple reference blocks. Regardless of the value of the intraTMP fusion flag, the sparse search and refinement search passes may be performed to construct a candidate list of N intraTMP block vectors, chosen by selecting block vectors according to the SAD cost calculated over the template area. Additional details of the candidate list construction process are provided below. In this solution, N is greater than or equal to 15. Let the block vectors from the intraTMP candidate list be labeled bv₀, bv₁, . . . bv_{N-1}. Let the reference blocks corresponding to the block vectors from the intraTMP candidate list be labeled r₀, r₁, . . . r_{N-1}.

If the current block is predicted by an intraTMP fusion mode (intra_tmp_fusion_flag is 1), then both an intraTMP fusion index (intra_tmp_fusion_idx) and an intraTMP fusion weight type (intra_tmp_fusion_weight_type) are signaled in the bitstream. The fused predictor is determined according to equation (9).

$${p}_{fusion} = {w}_{N} \cdot midVal + {\sum }_{i = A}^{B} {w}_{i} {r}_{i} , \qquad ( 9 )$$

where the reference blocks selected for fusion are determined by the intraTMP fusion index. The intraTMP fusion index can take a value of 0, 1, or 2. When intra_tmp_fusion_idx is 0, then A=0 and B=4. That is, the five reference blocks corresponding to the first five intraTMP block vectors from the candidate list are selected for fusion (r₀, r₁, r₂, r₃, r₄). When intra_tmp_fusion_idx is 1, then A=5 and B=9. When intra_tmp_fusion_idx is 2, then A=10 and B=14. midVal is set to the middle value of the video samples. For example, if the bit depth is B, then midVal=2^{B-1}. An example binarization of intra_tmp_fusion_idx is shown below in Table 3.

TABLE 3
Binarization of intra_tmp_fusion_idx

| Value | Binarization |
|---|---|
| 0 | 0 |
| 1 | 10 |
| 2 | 11 |

The method by which the fusion weights are calculated is selected by the intraTMP fusion weight type (intra_tmp_fusion_weight_type), which is a flag that can take a value of 0 or 1. For example, when intra_tmp_fusion_weight_type is 0, then the weights may be determined by a SAD-based algorithm (see equations (10) and (11) below), where SADᵢ denotes the SAD cost of the i^{th} intraTMP candidate.

$$sum = {\sum }_{i = A}^{B} S A {D}_{i} ; and \qquad ( 10 )$$

$$\begin{matrix}{w}_{i} = \frac{sum - {SAD}_{i}}{4 \cdot sum} , & {w}_{N} = 0\end{matrix} . \qquad ( 11 )$$

When intra_tmp_fusion_weight_type is 1, then the set of six weights {w_{A}, w_{A+1}, . . . w_{B}, w_{N}} may instead be determined by minimising the MSE between the fusion of neighbouring template regions of the five reference blocks and the neighbour template region of the current block. That is, if the neighbouring template of each reference block rᵢ is tᵢ, and the neighbouring template of the current block is t, then the weights may be determined according to expression (12).

$${arg min}_{{w}_{i}} {\vert t - {w}_{N} \cdot midVal - {\sum }_{i = A}^{B} {w}_{i} {t}_{i} \vert}^{2} . \qquad ( 12 )$$

As described, one method of solving such a minimization problem is by LDL decomposition.

If the current block is predicted by intraTMP, but not by intraTMP fusion (intra_tmp_fusion_flag is 0), then an intraTMP index is signaled to identify a single block vector from the candidate list. The same candidate list is constructed regardless of whether intraTMP fusion is used or not. However, the candidate list construction is modified relative to the known methods described above to incorporate both the aspects of search for multiple candidates by sparse and refinement passes, and search for candidates using different template shapes.

In the sparse search, candidate block vectors are found in parallel, which minimises the SAD cost calculated over L-shaped templates, left-only templates, and top-only templates. Although the same block vectors may be chosen, the SAD costs for different shape templates cannot be compared. If M candidates are kept for each sparse search, then 3×M candidate BVs in total are kept after the sparse search, with M for each template-shape type. In the refinement search, 3×3 local search with the corresponding template shape is performed around each of the sparse candidate BVs. In some implementations, this search algorithm can be optimised significantly since the left-only template cost and top-only template cost can be calculated at the same time as the L-shaped template cost.

In one arrangement, the candidate list length may be increased to 19 to accommodate the greater variety of block vectors. Up to 19 block vectors with the lowest SAD cost over L-shape template are selected, arranged in order of the block vector with the lowest SAD cost first and followed by block vectors with associated SAD costs following an ascending order. Similarly, up to 3 block vectors with the lowest SAD cost over left-only template are selected, arranged in ascending order, and up to 3 block vectors with the lowest SAD cost over left-only template are selected with SAD costs in ascending order. In the case where all the block vectors are unique, then 13 L-shape template candidates, 3 left-only template candidates, and 3 top-only candidates are used to construct the candidate list. The L-shape template candidates populate the lowest indices. This is due to the binarization scheme used for signaling the intraTMP index. This means these candidates use less overhead to signal. Block vectors selected using the left-only template or top-only template search generally have lower SAD costs because they have a smaller template area, but the L-template candidate block vectors are preferred because the L-shape template is more likely to find a good predictor for the current block. When any BVs found by the different template-shape searches are identical, then the redundant BVs are pruned away from the top-only or left-only candidates. For example, if just 1 left-only template candidate is unique, and just 2 top-only template candidates are unique, then the final candidate list will be constructed from 16 L-shape template candidates, 1 left-only template candidate, and 2 top-only candidates.

In another arrangement, the candidate list length is 19. Up to 19 BVs with the lowest SAD cost over L-shape template are selected, while up to 2 BVs with the lowest SAD cost over left-only template are selected, and up to 2 BVs with the lowest SAD cost over left-only template are selected. For example, in the case where all the BVs are unique, then 15 L-shape template candidates, 2 left-only template candidates, and 2 top-only candidates are used to construct the candidate list.

In one arrangement, the candidate list is constructed by candidate BVs from the L-shape template search followed by candidates from the other template shapes in a fixed order, such as the candidates from the top-only template search next, then the candidates from the left-only template search.

In another arrangement, the candidate list is constructed by candidate BVs from the L-shape template search followed by candidates from the template shape with the next largest area, and then finally by candidates from the template shape with the smallest area. For example, if the top-only template area is larger than the left-only template area, then the candidate list is constructed by candidate block vectors from the L-shape template search, followed by candidates from the top-only template search, and finally by candidates from the left-only search. The template areas are dependent on the height (h) and width (w) of the current block. For example, if h>w, then the left-only template area is larger than the top-only template area.

When the candidate list length is 19, the intra_tmp_idx syntax element may take a value from 0 to 18, with binarization as shown in Table 4 where x represents either 0 or 1.

TABLE 4
Binarization of intra_tmp_idx when candidate list length is 19

| Value | Binarization |
|---|---|
| 0 | 11 |
| 1 | 100 |
| 2 | 101 |
| 3-18 | 0xxxx |

That is, when intra_tmp_idx has a value in the range 3 to 18, it is signaled in the bitstream by a 0 followed by (intra_tmp_idx−2) expressed as a 4-bit fixed length code.

If the current block is predicted by intraTMP but not by intraTMP fusion (intra_tmp_fusion_flag is 0), then along with the intraTMP index an intraTMP filter flag (intra_tmp_filter_flag) is signaled to indicate whether the prediction block is determined by filtering the selected reference block rᵢ. When intra_tmp_filter_flag is 1, the prediction block is determined by filtering with a learned filter c, according to equation (13). The learned filter c in equation (13) may be determined by equation (14).

$${P}_{filtered} = c * {r}_{i} + {c}_{5} \cdot midVal ; and \qquad ( 13 )$$

$$c = [ \begin{matrix}0 & {c}_{1} & 0 \\ {c}_{3} & {c}_{0} & {c}_{4} \\ 0 & {c}_{2} & 0\end{matrix} ] , \qquad ( 14 )$$

where * denotes the convolution operator. The set of six coefficients {c₀, c₁, . . . c₅} are determined by minimising the MSE between the filtered neighbour template region of the selected reference block and the neighbour template region of the current block, as shown in expression (15).

$${arg min}_{c} {\vert t - {c}_{5} \cdot midVal - c * {r}_{i} \vert}^{2} . \qquad ( 15 )$$

If the current block is predicted by intraTMP, but not by intraTMP fusion and not by intraTMP filtering (intra_tmp_filter_flag is 0), then an intraTMP sub-pixel flag (intra_tmp_sub_pel_flag) may be signaled to indicate whether the intraTMP BV is further refined with fractional precision. If intra_tmp_sub_pel_flag is 0, then the intraTMP block vector is not further modified. Then, the prediction block is the selected reference block rᵢ.

If intra_tmp_sub_pel_flag is 1, then the intraTMP BV is further refined by signaling a sub-pixel refinement direction (intra_tmp_sub_pel_direction_idx) and a sub-pixel refinement phase (intra_tmp_sub_pel_phase_idx).

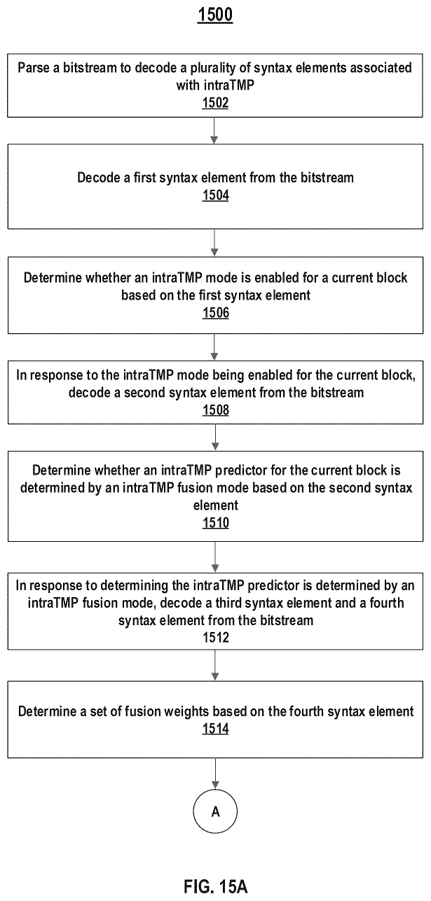

FIG. 14 illustrates a diagram of fractional block vector positions 1400 for intraTMP, according to some embodiments of the present disclosure.

Referring to FIG. 14, the intraTMP block vector selected by indexing into the candidate list has integer-level precision. In FIG. 14, the black circles represent the integer spaced coordinate space of block vectors, with the middle circle representing the selected intraTMP block vector bvᵢ. The white circles represent the 24 sub-pixel refined block vectors that can be signalled by this solution's signalling mechanism.

Then, the sub-pixel refinement may proceed in one of 8 directions, as shown in FIG. 14 by arrows. intra_tmp_sub_pel_direction_idx signals the sub-pixel refinement direction by taking a value in the range 0 to 7, signaled as a 3-bit fixed length code. The distance the sub-pixel-refined block vector is from bvᵢ is signaled by intra_tmp_sub_pel_phase_idx, which signals the value 0 to indicate a phase of ¼, the value 1 to indicate a phase of ½, and the value 2 to indicate a phase of ¾. The binarization of intra_tmp_sub_pel_phase_idx may be indicated according to Table 5.

TABLE 5
Binarization of intra_tmp_sub_pel_phase_idx

| Value | Binarization |
|---|---|
| 0 | 0 |
| 1 | 10 |
| 2 | 11 |

The prediction block with sub-pixel refinement is determined by applying 1-dimensional interpolation filters in a separable manner, with ¼, ½, or ¾ phase interpolation filters used to achieve the desired interpolation. The interpolation filters may be re-used from existing interpolation filters used in ECM for motion compensation, or existing ECM filters used for intra reference sample interpolation, or they may be interpolation filters specifically designed for intraTMP.

Syntax elements that are signaled without dependency on each other may be signaled in a different order. For example, the signaling order of intra_tmp_fusion_idx and intra_tmp_fusion_weight_type may be reversed, or the signaling order of intra_tmp_idx and intra_tmp_filter_flag may be reversed, or the signaling order of intra_tmp_sub_pel_phase_idx and intra_tmp_sub_pel_direction_idx may be reversed, without any change on the coding efficiency of the intraTMP coding tools. For example, in some implementations, the syntax signaling order may be summarized as follows:

```
intra_tmp_flag
if ( intra_tmp_flag ){
  intra_tmp_fusion_flag
  if ( intra_tmp_fusion_flag ) {
    intra_tmp_fusion_idx
    intra_tmp_fusion_weight_type
  }
  else {
    intra_tmp_idx
    intra_tmp_filter_flag
    if ( !intra_tmp_filter_flag ) {
      intra_tmp_sub_pel_flag
      if ( intra_tmp_sub_pel_flag ) {
        intra_tmp_sub_pel_phase_idx
        intra_tmp_sub_pel_direction_idx
      }
    }
  }
}
```

In some implementations, the intra_tmp_sub_pel_flag and intra_tmp_sub_pel_phase_idx syntax elements may be merged into a single syntax element (intra_tmp_sub_pel_precision_idx) that signals the distance of the sub-pixel refined BV from bvᵢ. If intra_tmp_sub_pel_precision_idx is 0, then the phase is 0, which means that the original block vector bvᵢ is used. In such a case, sub-pixel block vector refinement is not used, so the sub-pixel refinement direction is not signaled. If intra_tmp_sub_pel_precision_idx is 1, then the phase is ¼. If intra_tmp_sub_pel_precision_idx is 2, then the phase is ½. If intra_tmp_sub_pel_precision_idx is 3, then the phase is ¾. The binarization of intra_tmp_sub_pel_precision_idx may be the same as the concatenation of the intra_tmp_filter_flag and intra_tmp_sub_pel_phase_idx syntax elements. This binarization may be indicated as shown in Table 6.

TABLE 6
Binarization of intra_tmp_sub_pel_precision_idx

| Value | Binarization |
|---|---|
| 0 | 0 |
| 1 | 10 |
| 2 | 110 |
| 3 | 111 |

Correspondingly, the syntax element dependencies and signaling order may be summarized by:

```
intra_tmp_flag
if ( intra_tmp_flag ){
  intra_tmp_fusion_flag
  if ( intra_tmp_fusion_flag ) {
    intra_tmp_fusion_idx
    intra_tmp_fusion_weight_type
  }
  else {
    intra_tmp_idx
    intra_tmp_filter_flag
    if ( !intra_tmp_filter_flag ) {
      intra_tmp_sub_pel_precision_idx
      if ( intra_tmp_sub_pel_precision_idx != 0 ) {
        intra_tmp_sub_pel_direction_idx
      }
    }
  }
}
```

Referring to FIG. 3, transform module 308 can transform the video signals in the residual block from the pixel domain to a transform domain (e.g., a frequency domain depending on the transform method). It is understood that in some examples, transform module 308 may be skipped, and the video signals may not be transformed to the transform domain.

Quantization module 310 may be configured to quantize the coefficient of each position in the coding block to generate quantization levels of the positions. The current block may be the residual block. That is, quantization module 310 can perform a quantization process on each residual block. The residual block may include N×M positions (samples), each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 310. Which quantizer will be used for quantizing the current coefficient may depend on the information preceding the current coefficient in coding scan order. Such a quantization process is referred to as dependent quantization.

Referring to FIG. 3, encoding module 320 may be configured to encode the quantization level of each position in the coding block into the bitstream. In some embodiments, encoding module 320 may perform entropy encoding on the coding block. Entropy encoding may use various binarization methods, such as Golomb-Rice binarization, to convert each quantization level into a respective binary representation, such as binary bins. Then, the binary representation can be further compressed using entropy encoding algorithms. The compressed data may be added to the bitstream. Besides the quantization levels, encoding module 320 may encode various other information, such as block type information of a coding unit, prediction mode information, partitioning unit information, prediction unit information, transmission unit information, motion vector information, reference frame information, block interpolation information, and filtering information input from, for example, prediction modules 304 and 306. In some embodiments, encoding module 320 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined Truncated Rice (TR) and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of context-adaptive binary arithmetic coding (CABAC) can support two operating modes: a context coding mode, in which the bins are coded with adaptive probability models, and a less complex bypass mode that uses fixed probabilities of ½. The adaptive probability models are also called contexts, and the assignment of probability models to individual bins is referred to as context modeling.

As shown in FIG. 3, dequantization module 312 may be configured to dequantize the quantization levels by dequantization module 312, and inverse transform module 314 may be configured to inversely transform the coefficients transformed by transform module 308. The reconstructed residual block generated by dequantization module 312 and inverse transform module 314 may be combined with the prediction units predicted through prediction module 304 or 306 to generate a reconstructed block.

Filter module 316 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 318 may be configured to store the reconstructed block or picture calculated through filter module 316, and the reconstructed and stored block or picture may be provided to inter prediction module 304 when inter prediction is performed.

FIG. 4 illustrates a detailed block diagram of exemplary decoder 201 in decoding system 200 in FIG. 2, according to some embodiments of the present disclosure. As shown in FIG. 4, decoder 201 may include a decoding module 402, a dequantization module 404, an inverse transform module 406, an inter prediction module 408, an intra prediction module 410, a filter module 412, and a buffer module 414. It is understood that each of the elements shown in FIG. 4 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201.

When a video bitstream is input from a video encoder (e.g., encoder 101), the input bitstream may be decoded by decoder 201 in a procedure opposite to that of the video encoder. Thus, some details of decoding that are described above with respect to encoding may be skipped for ease of description. Decoding module 402 may be configured to decode the bitstream to obtain various information encoded into the bitstream, such as the quantization level of each position in the coding block. In some embodiments, decoding module 402 may perform entropy decoding (decompressing) corresponding to the entropy encoding (compressing) performed by the encoder, such as, for example, video local-area network (VideoLAN) coding (VLC), context-adaptive variable-length coding (CAVLC), CABAC, syntax-based binary arithmetic coding (SBAC), PIPE coding, and the like to obtain the binary representation (e.g., binary bins). Decoding module 402 may further convert the binary representations to quantization levels using Golomb-Rice binarization, including, for example, EGk binarization and combined TR and limited EGk binarization. Besides the quantization levels of the positions in the transform units, decoding module 402 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 402 may perform rearrangement on the bitstream to reconstruct and rearrange the data from a 1D order into a 2D rearranged block through a method of inverse-scanning based on the coding scan order used by the encoder.

Dequantization module 404 may be configured to dequantize the quantization level of each position of the coding block (e.g., the 2D reconstructed block) to obtain the coefficient of each position. In some embodiments, dequantization module 404 may perform dependent dequantization based on quantization parameters provided by the encoder as well, including the information related to the quantizers used in dependent quantization, for example, the quantization step size used by each quantizer.

Inverse transform module 406 may be configured to perform inverse transformation, for example, inverse DCT, inverse discrete sine transform (DST), and inverse KLT, for DCT, DST, and KLT, LFNST, and/or NSPT performed by the encoder, respectively, to transform the data from the transform domain (e.g., coefficients) back to the pixel domain (e.g., luma and/or chroma information). In some embodiments, inverse transform module 406 may selectively perform a transform operation (e.g., DCT, DST, KLT, LFNST, NSPT) according to a plurality of pieces of information such as a prediction method, a size of the current block, a prediction direction, and the like.

Additionally and/or alternatively, inter prediction module 408 and intra prediction module 410 may be configured to generate a prediction block based on information related to the generation of a prediction block provided by decoding module 402 and information of a previously decoded block or picture provided by buffer module 414. As described above, if the size of the prediction unit and the size of the transform unit are the same when intra prediction is performed in the same manner as the operation of the encoder, intra prediction may be performed on the prediction unit based on the pixel existing on the left side, the pixel on the top-left side, and the pixel on the top of the prediction unit. However, if the size of the prediction unit and the size of the transform unit are different when intra prediction is performed, intra prediction may be performed using a reference pixel based on a transform unit.

For example, inter prediction module 408 may be configured to receive a bitstream that includes a reference frame, a current frame, and an indication of a weighting factor associated with a multimedia home platform (MHP) procedure from an encoder. Inter prediction module 408 may be configured to perform the MHP procedure for a CU located in the current frame based on a search block (e.g., reference frame and/or reference template) in the reference frame. In some embodiments, to perform the MHP procedure, the inter prediction module 408 may be configured to perform template matching for the CU located in the current frame based on a search block in the reference frame and the weighting factor to obtain motion information. In some embodiments, to perform the MHP procedures, inter prediction module 408 may be configured to identify a weighting factor index associated with the weighting factor based on the template matching. Inter prediction module 408 may be configured to identify a weighting factor sign of the weighting factor based on an indication included in the bitstream. Inter prediction module 408 may be configured to perform an inter prediction procedure based on the current frame, the reference frame, the weighting factor index, and the weighting factor sign of the weighting factor to decode the bitstream.

The reconstructed block or reconstructed picture combined from the outputs of inverse transform module 406 and prediction module 408 or 410 may be provided to filter module 412. Filter module 412 may include a deblocking filter, an offset correction module, and an ALF. Buffer module 414 may store the reconstructed picture or block and use it as a reference picture or a reference block for inter prediction module 408 and may output the reconstructed picture.

Consistent with the scope of the present disclosure, encoding module 320 and decoding module 402 may be configured to adopt a scheme of quantization level binarization with Rice parameter adapted to the bit depth and/or the bit rate for encoding the picture of the video to improve the coding efficiency.

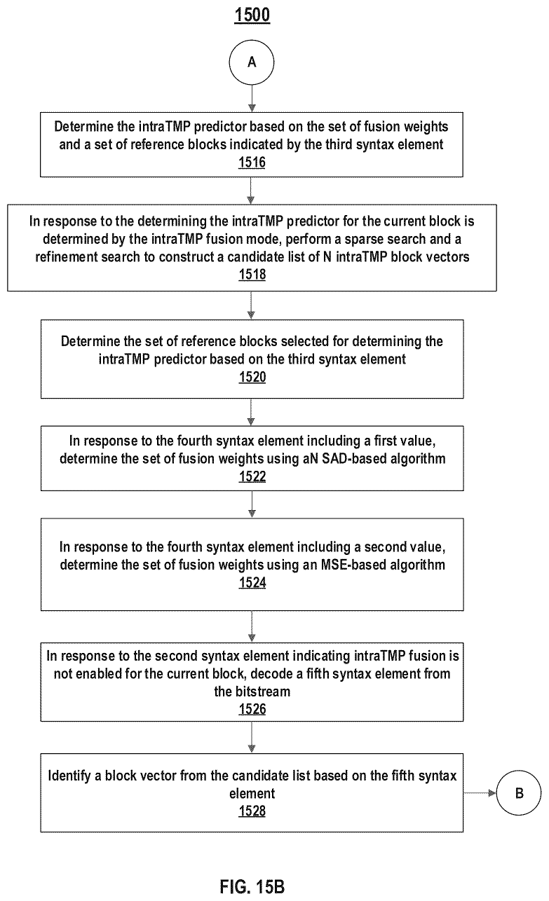

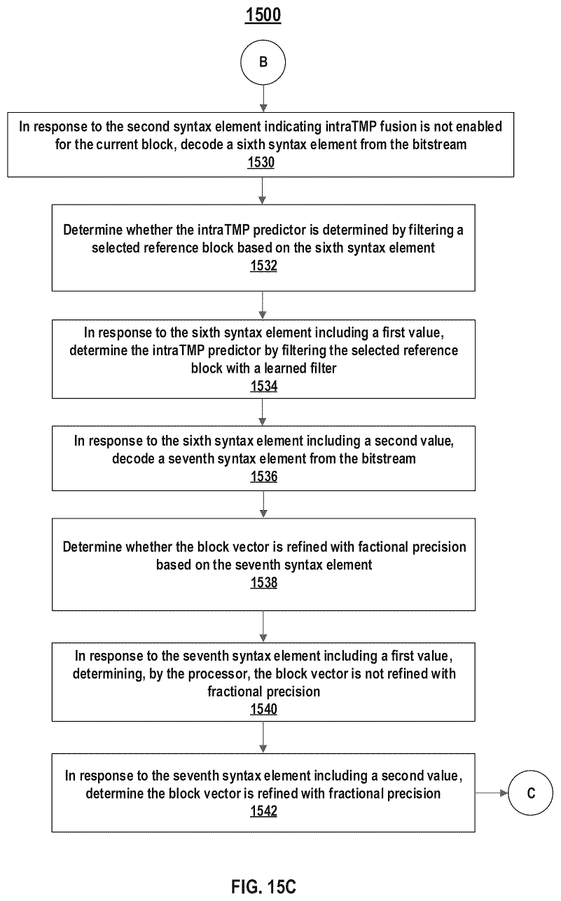

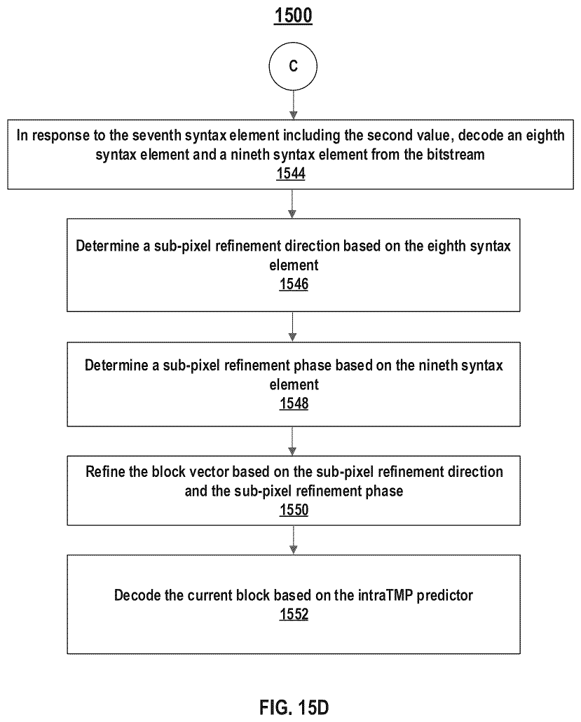

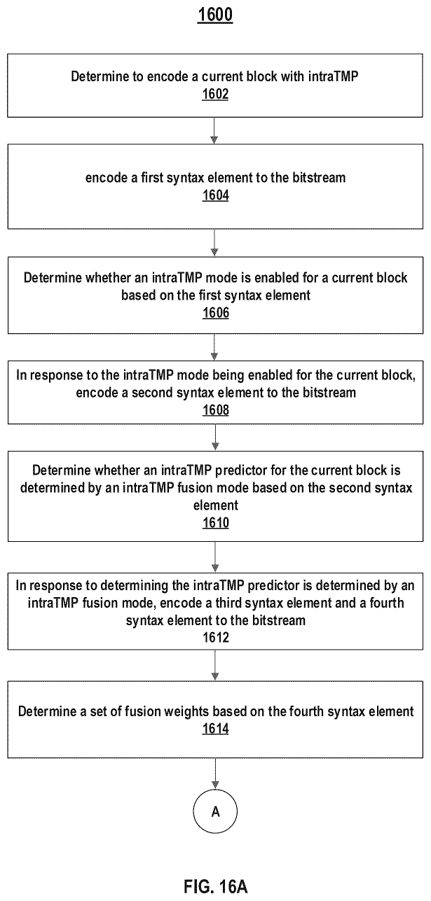

FIGS. 15A-15D illustrates a flowchart of an exemplary method 1500 of video decoding, according to some embodiments of the present disclosure. Method 1500 may be performed by a system, e.g., such as decoding system 200, decoder 201, or intra prediction module 410, just to name a few. Method 1500 may include operations 1502-1552, as described below. It is to be appreciated that some of the steps may be optional, and some of the steps may be performed simultaneously, or in a different order than shown in FIGS. 15A-15D.

Referring to FIG. 15A, at 1502, the system may parse a bitstream to decode a plurality of syntax elements associated with intraTMP.

At 1504, the system may decode a first syntax element from the bitstream. For example, an intraTMP flag (intra_tmp_flag) may be signaled to indicate if the current block is predicted by intraTMP. This syntax element may be decoded from the bitstream, or it may have an inferred value. For example, the intraTMP flag may have an inferred value of 0 if the intraTMP tool is disabled at a higher syntax level, e.g., such as in a sequence parameter set (SPS).

At 1506, the system may determine whether an intraTMP mode is enabled for a current block based on the first syntax element. For example, an intraTMP flag (intra_tmp_flag) may be signaled to indicate if the current block is predicted by intraTMP. This syntax element may be decoded from the bitstream, or it may have an inferred value. For example, the intraTMP flag may have an inferred value of 0 if the intraTMP tool is disabled at a higher syntax level, e.g., such as in a sequence parameter set (SPS).

At 1508, the system may, in response to the intraTMP mode being enabled for the current block, decode a second syntax element from the bitstream. For example, if the current block is predicted by intraTMP, then an intraTMP fusion flag (intra_tmp_fusion_flag) may be signaled to indicate if the intraTMP predictor is determined by fusing multiple reference blocks.

At 1510, the system may determine whether an intraTMP predictor for the current block is determined by an intraTMP fusion mode based on the second syntax element. For example, if the current block is predicted by an intraTMP fusion mode, the value of intra_tmp_fusion_flag may be signaled as 1; otherwise, the value may be signaled as 0.

At 1512, the system may, in response to determining the intraTMP predictor is determined by an intraTMP fusion mode, decode a third syntax element and a fourth syntax element from the bitstream. For example, if the current block is predicted by an intraTMP fusion mode (intra_tmp_fusion_flag is 1), then both an intraTMP fusion index (intra_tmp_fusion_idx) and an intraTMP fusion weight type (intra_tmp_fusion_weight_type) are signaled in the bitstream.

At 1514, the system may determine a set of fusion weights based on the fourth syntax element. For example, the method by which the fusion weights are calculated is selected by the intraTMP fusion weight type (intra_tmp_fusion_weight_type), which is a flag that can take a value of 0 or 1. For example, when intra_tmp_fusion_weight_type is 0, then the weights may be determined by a SAD-based algorithm (see equations (10) and (11) below),where SADᵢ denotes the SAD cost of the i^{th} intraTMP candidate. When intra_tmp_fusion_weight_type is 1, then the set of six weights {w_{A}, w_{A+1}, . . . w_{B}, w_{N}} may instead be determined by minimising the MSE between the fusion of neighbouring template regions of the five reference blocks and the neighbour template region of the current block. That is, if the neighbouring template of each reference block rᵢ is tᵢ, and the neighbouring template of the current block is t, then the weights may be determined according to expression (12).

Referring to FIG. 15B, at 1516, the system may determine the intraTMP predictor based on the set of fusion weights and a set of reference blocks indicated by the third syntax element. For example, the intraTMP predictor may be determined based on the fusion weights calculated by the SAD-based algorithm or the MSE-based algorithm and the reference blocks.

At 1518, the system may, in response to the determining the intraTMP predictor for the current block is determined by the intraTMP fusion mode, perform a sparse search and a refinement search to construct a candidate list of N intraTMP block vectors. For example, if the current block is predicted by intraTMP, then an intraTMP fusion flag (intra_tmp_fusion_flag) may be signaled to indicate if the intraTMP predictor is determined by fusing multiple reference blocks. Regardless of the value of the intraTMP fusion flag, the sparse search and refinement search passes may be performed to construct a candidate list of N intraTMP block vectors, chosen by selecting block vectors according to the SAD cost calculated over the template area. Additional details of the candidate list construction process are provided below. In this solution, N is greater than or equal to 15. Let the block vectors from the intraTMP candidate list be labeled bv₀, bv₁, . . . bv_{N-1}. Let the reference blocks corresponding to the block vectors from the intraTMP candidate list be labeled r₀, r₁, . . . r_{N-1}.

At 1520, the system may determine the set of reference blocks selected for determining the intraTMP predictor based on the third syntax element. For example, if the current block is predicted by an intraTMP fusion mode (intra_tmp_fusion_flag is 1), then both an intraTMP fusion index (intra_tmp_fusion_idx) and an intraTMP fusion weight type (intra_tmp_fusion_weight_type) are signaled in the bitstream. The fused predictor is determined according to equation (9). In equation (9), the reference blocks selected for fusion are determined by the intraTMP fusion index. The intraTMP fusion index can take a value of 0, 1, or 2. When intra_tmp_fusion_idx is 0, then A=0 and B=4. That is, the five reference blocks corresponding to the first five intraTMP block vectors from the candidate list are selected for fusion (r₀, r₁, r₂, r₃, r₄). When intra_tmp_fusion_idx is 1, then A=5 and B=9. When intra_tmp_fusion_idx is 2, then A=10 and B=14. midVal is set to the middle value of the video samples. For example, if the bit depth is B, then midVal=2^{B-1}. An example binarization of intra_tmp_fusion_idx is shown below in Table 3.

At 1522, the system may, in response to the fourth syntax element including a first value, determine the set of fusion weights using an SAD-based algorithm. For example, when intra_tmp_fusion_weight_type is 0, then the weights may be determined by a SAD-based algorithm (see equations (10) and (11) above), where SADᵢ denotes the SAD cost of the i^{th} intraTMP candidate.

At 1524, the system may, in response to the fourth syntax element including a second value, determine the set of fusion weights using an MSE-based algorithm. For example, when intra_tmp_fusion_weight_type is 1, then the set of six weights {w_{A}, w_{A+1}, . . . w_{B}, w_{N}} may instead be determined by minimising the MSE between the fusion of neighbouring template regions of the five reference blocks and the neighbour template region of the current block. That is, if the neighbouring template of each reference block rᵢ is tᵢ, and the neighbouring template of the current block is t, then the weights may be determined according to expression (12).

At 1526, the system may, in response to the second syntax element indicating intraTMP fusion is not enabled for the current block, decode a fifth syntax element from the bitstream. For example, Ii the current block is predicted by intraTMP, but not by intraTMP fusion (intra_tmp_fusion_flag is 0), then an intraTMP index is signaled to identify a single block vector from the candidate list.

At 1528, the system may identify a block vector from the candidate list based on the fifth syntax element. For example, if the current block is predicted by intraTMP, but not by intraTMP fusion (intra_tmp_fusion_flag is 0), then an intraTMP index is signaled to identify a single block vector from the candidate list. The same candidate list is constructed regardless of whether intraTMP fusion is used or not. However, the candidate list construction is modified relative to the known methods described above to incorporate both the aspects of search for multiple candidates by sparse and refinement passes, and search for candidates using different template shapes.

Referring to FIG. 15C, at 1530, the system may, in response to the second syntax element indicating intraTMP fusion is not enabled for the current block, decode a sixth syntax element from the bitstream. For example, if the current block is predicted by intraTMP but not by intraTMP fusion (intra_tmp_fusion_flag is 0), then along with the intraTMP index an intraTMP filter flag (intra_tmp_filter_flag) is signaled to indicate whether the prediction block is determined by filtering the selected reference block rᵢ.

At 1532, the system may determine whether the intraTMP predictor is determined by filtering a selected reference block based on the sixth syntax element. For example, if the current block is predicted by intraTMP but not by intraTMP fusion (intra_tmp_fusion_flag is 0), then along with the intraTMP index an intraTMP filter flag (intra_tmp_filter_flag) is signaled to indicate whether the prediction block is determined by filtering the selected reference block rᵢ.

At 1534, the system may, in response to the sixth syntax element including a first value, determine the intraTMP predictor by filtering the selected reference block with a learned filter. For example, when intra_tmp_filter_flag is 1, the prediction block is determined by filtering with a learned filter c, according to equation (13). The learned filter c in equation (13) may be determined by equation (14).

At 1536, the system may, in response to the sixth syntax element including a second value, decode a seventh syntax element from the bitstream. For example, if the current block is predicted by intraTMP, but not by intraTMP fusion and not by intraTMP filtering (intra_tmp_filter_flag is 0), then an intraTMP sub-pixel flag (intra_tmp_sub_pel_flag) may be signaled to indicate whether the intraTMP BV is further refined with fractional precision.

At 1538, the system may determine whether the block vector is refined with factional precision based on the seventh syntax element. For example, if the current block is predicted by intraTMP, but not by intraTMP fusion and not by intraTMP filtering (intra_tmp_filter_flag is 0), then an intraTMP sub-pixel flag (intra_tmp_sub_pel_flag) may be signaled to indicate whether the intraTMP BV is further refined with fractional precision.

At 1540, the system may, in response to the seventh syntax element including a first value, determining, by the processor, the block vector is not refined with fractional precision.

At 1542, the system may, in response to the seventh syntax element including a second value, determine the block vector is refined with fractional precision. For example, if intra_tmp_sub_pel_flag is 0, then the intraTMP block vector is not further modified. Then, the prediction block is the selected reference block rᵢ.

Referring to FIG. 15D, at 1544, the system may, in response to the seventh syntax element including the second value, decode an eighth syntax element and a ninth syntax element from the bitstream. For example, if intra_tmp_sub_pel_flag is 1, then the intraTMP BV is further refined by signaling a sub-pixel refinement direction (intra_tmp_sub_pel_direction_idx) and a sub-pixel refinement phase (intra_tmp_sub_pel_phase_idx).

At 1546, the system may determine a sub-pixel refinement direction based on the eighth syntax element. For example, the sub-pixel refinement may proceed in one of 8 directions as shown in FIG. 14 by arrows. intra_tmp_sub_pel_direction_idx signals the sub-pixel refinement direction by taking a value in the range 0 to 7, signaled as a 3-bit fixed length code.

At 1548, the system may determine a sub-pixel refinement phase based on the ninth syntax element. For example, the distance the sub-pixel refined BV is from bvᵢ is signaled by intra_tmp_sub_pel_phase_idx, which signals the value 0 to indicate a phase of ¼, the value 1 to indicate a phase of ½, and the value 2 to indicate a phase of ¾.

At 1550, the system may refine the block vector based on the sub-pixel refinement direction and the sub-pixel refinement phase. For example, the prediction block with sub-pixel refinement is determined by applying 1-dimensional interpolation filters in a separable manner, with ¼, ½, or ¾ phase interpolation filters used to achieve the desired interpolation. The interpolation filters may be re-used from existing interpolation filters used in ECM for motion compensation, or existing ECM filters used for intra reference sample interpolation, or they may be interpolation filters specifically designed for intraTMP.

At 1552, the system may decode the current block based on the intraTMP predictor. For example, decoder 201 may decode the current block based on the intraTMP predictor determined based on the various syntax elements parsed from the bitstream as described above.

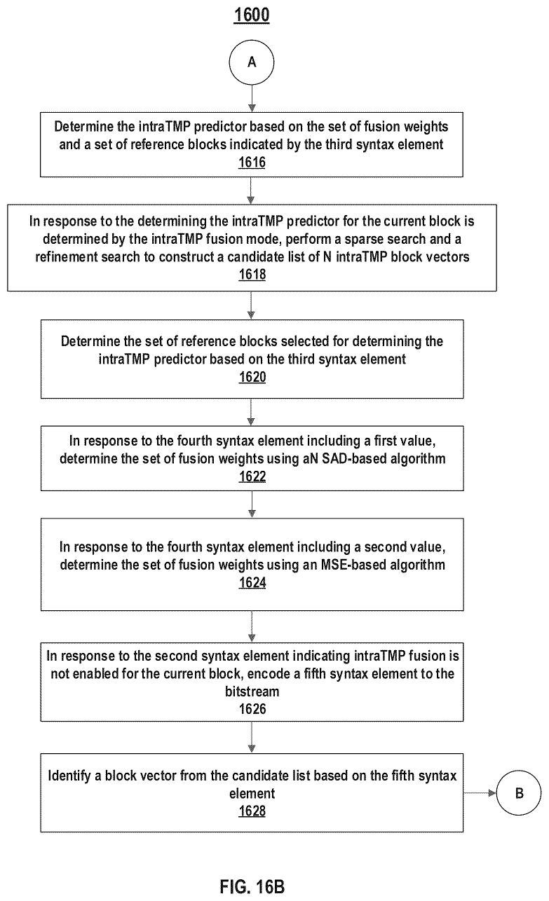

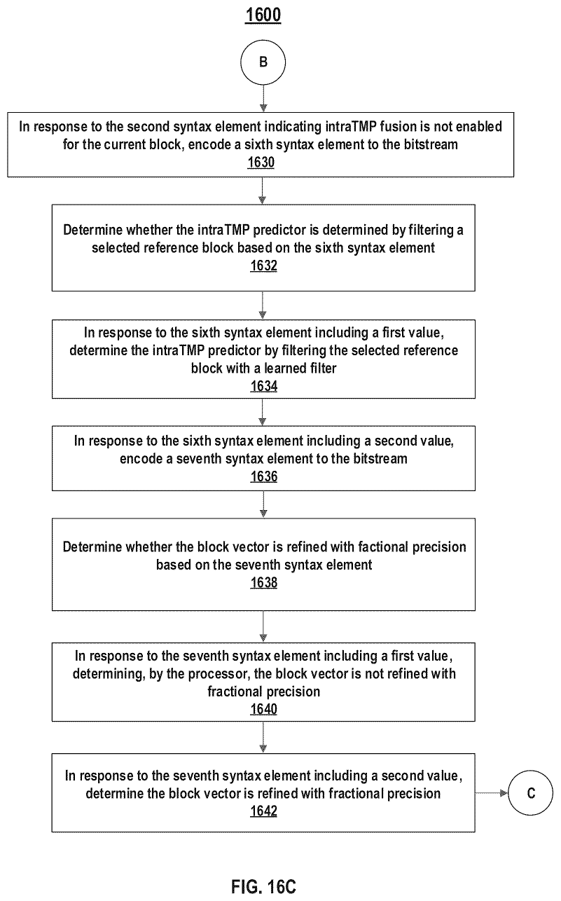

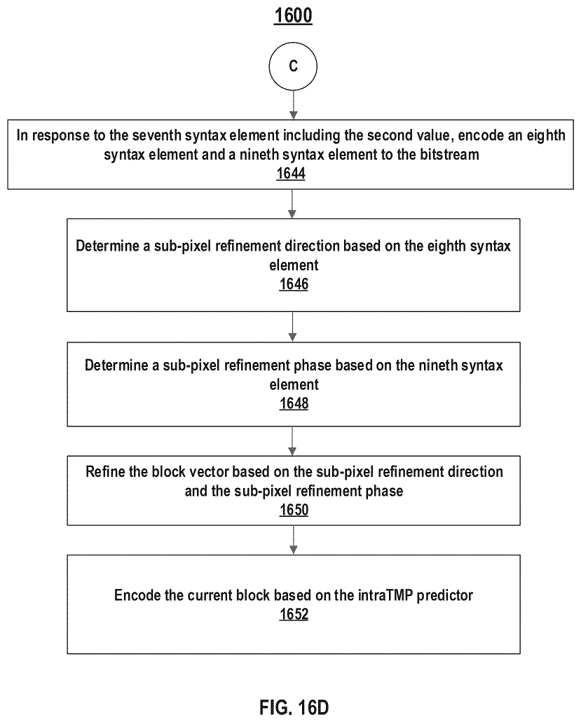

FIGS. 16A-16D illustrates a flowchart of an exemplary method 1600 of video encoding, according to some embodiments of the present disclosure. Method 1600 may be performed by a system, e.g., such as encoding system 200, encoder 101, or intra prediction module 410, just to name a few. Method 1600 may include operations 1602-1652, as described below. It is to be appreciated that some of the steps may be optional, and some of the steps may be performed simultaneously, or in a different order than shown in FIGS. 16A-16D.

Referring to FIG. 16A, at 1602, the system may determine a current block is encoded with intraTMP. For example, encoder 101 may determine a current block is encoded with intraTMP.

At 1604, the system may encode a first syntax element to the bitstream. For example, an intraTMP flag (intra_tmp_flag) may be signaled to indicate if the current block is predicted by intraTMP. This syntax element may be encoded to the bitstream, or it may have an inferred value. For example, the intraTMP flag may have an inferred value of 0 if the intraTMP tool is disabled at a higher syntax level, e.g., such as in a sequence parameter set (SPS).

At 1606, the system may determine whether an intraTMP mode is enabled for a current block based on the first syntax element. For example, an intraTMP flag (intra_tmp_flag) may be signaled to indicate if the current block is predicted by intraTMP. This syntax element may be encoded to the bitstream, or it may have an inferred value. For example, the intraTMP flag may have an inferred value of 0 if the intraTMP tool is disabled at a higher syntax level, e.g., such as in a sequence parameter set (SPS).

At 1608, the system may, in response to the intraTMP mode being enabled for the current block, encode a second syntax element to the bitstream. For example, if the current block is predicted by intraTMP, then an intraTMP fusion flag (intra_tmp_fusion_flag) may be signaled to indicate if the intraTMP predictor is determined by fusing multiple reference blocks.

At 1610, the system may determine whether an intraTMP predictor for the current block is determined by an intraTMP fusion mode based on the second syntax element. For example, if the current block is predicted by an intraTMP fusion mode, the value of intra_tmp_fusion_flag may be signaled as 1; otherwise, the value may be signaled as 0.

At 1612, the system may, in response to determining the intraTMP predictor is determined by an intraTMP fusion mode, encode a third syntax element and a fourth syntax element to the bitstream. For example, if the current block is predicted by an intraTMP fusion mode (intra_tmp_fusion_flag is 1), then both an intraTMP fusion index (intra_tmp_fusion_idx) and an intraTMP fusion weight type (intra_tmp_fusion_weight_type) are signaled in the bitstream.

At 1614, the system may determine a set of fusion weights based on the fourth syntax element. For example, the method by which the fusion weights are calculated is selected by the intraTMP fusion weight type (intra_tmp_fusion_weight_type), which is a flag that can take a value of 0 or 1. For example, when intra_tmp_fusion_weight_type is 0, then the weights may be determined by a SAD-based algorithm (see equations (10) and (11) below), where SADᵢ denotes the SAD cost of the i^{th} intraTMP candidate. When intra_tmp_fusion_weight_type is 1, then the set of six weights {w_{A}, w_{A+1}, . . . w_{B}, w_{N}} may instead be determined by minimising the MSE between the fusion of neighbouring template regions of the five reference blocks and the neighbour template region of the current block. That is, if the neighbouring template of each reference block rᵢ is tᵢ, and the neighbouring template of the current block is t, then the weights may be determined according to expression (12).

Referring to FIG. 16B, at 1616, the system may determine the intraTMP predictor based on the set of fusion weights and a set of reference blocks indicated by the third syntax element. For example, the intraTMP predictor may be determined based on the fusion weights calculated by the SAD-based algorithm or the MSE-based algorithm and the reference blocks.

At 1618, the system may, in response to the determining the intraTMP predictor for the current block is determined by the intraTMP fusion mode, perform a sparse search and a refinement search to construct a candidate list of N intraTMP block vectors. For example, if the current block is predicted by intraTMP, then an intraTMP fusion flag (intra_tmp_fusion_flag) may be signaled to indicate if the intraTMP predictor is determined by fusing multiple reference blocks. Regardless of the value of the intraTMP fusion flag, the sparse search and refinement search passes may be performed to construct a candidate list of N intraTMP block vectors, chosen by selecting block vectors according to the SAD cost calculated over the template area. Additional details of the candidate list construction process are provided below. In this solution, N is greater than or equal to 16. Let the block vectors from the intraTMP candidate list be labeled bv₀, bv₁, . . . bv_{N-1}. Let the reference blocks corresponding to the block vectors from the intraTMP candidate list be labeled r₀, r₁, . . . r_{N-1}.

At 1620, the system may determine the set of reference blocks selected for determining the intraTMP predictor based on the third syntax element. For example, if the current block is predicted by an intraTMP fusion mode (intra_tmp_fusion_flag is 1), then both an intraTMP fusion index (intra_tmp_fusion_idx) and an intraTMP fusion weight type (intra_tmp_fusion_weight_type) are signaled in the bitstream. The fused predictor is determined according to equation (9). In equation (9), the reference blocks selected for fusion are determined by the intraTMP fusion index. The intraTMP fusion index can take a value of 0, 1, or 2. When intra_tmp_fusion_idx is 0, then A=0 and B=4. That is, the five reference blocks corresponding to the first five intraTMP block vectors from the candidate list are selected for fusion (r₀, r₁, r₂, r₃, r₄). When intra_tmp_fusion_idx is 1, then A=5 and B=9. When intra_tmp_fusion_idx is 2, then A=10 and B=14. midVal is set to the middle value of the video samples. For example, if the bit depth is B, then midVal=2-1. An example binarization of intra_tmp_fusion_idx is shown below in Table 3.

At 1622, the system may, in response to the fourth syntax element including a first value, determine the set of fusion weights using an SAD-based algorithm. For example, when intra_tmp_fusion_weight_type is 0, then the weights may be determined by a SAD-based algorithm (see equations (10) and (11) above), where SAD, denotes the SAD cost of the i^{th} intraTMP candidate.

At 1624, the system may, in response to the fourth syntax element including a second value, determine the set of fusion weights using an MSE-based algorithm. For example, when intra_tmp_fusion_weight_type is 1, then the set of six weights {w_{A}, w_{A}+1, . . . w_{B}, w_{N}} may instead be determined by minimising the MSE between the fusion of neighbouring template regions of the five reference blocks and the neighbour template region of the current block. That is, if the neighbouring template of each reference block rᵢ is tᵢ, and the neighbouring template of the current block is t, then the weights may be determined according to expression (12).

At 1626, the system may, in response to the second syntax element indicating intraTMP fusion is not enabled for the current block, encode a fifth syntax element to the bitstream. For example, the current block is predicted by intraTMP, but not by intraTMP fusion (intra_tmp_fusion_flag is 0), then an intraTMP index is signaled to identify a single block vector from the candidate list.

At 1628, the system may identify a block vector from the candidate list based on the fifth syntax element. For example, if the current block is predicted by intraTMP, but not by intraTMP fusion (intra_tmp_fusion_flag is 0), then an intraTMP index is signaled to identify a single block vector from the candidate list. The same candidate list is constructed regardless of whether intraTMP fusion is used or not. However, the candidate list construction is modified relative to the known methods described above to incorporate both the aspects of search for multiple candidates by sparse and refinement passes, and search for candidates using different template shapes.

Referring to FIG. 16C, at 1630, the system may, in response to the second syntax element indicating intraTMP fusion is not enabled for the current block, encode a sixth syntax element to the bitstream. For example, if the current block is predicted by intraTMP but not by intraTMP fusion (intra_tmp_fusion_flag is 0), then along with the intraTMP index an intraTMP filter flag (intra_tmp_filter_flag) is signaled to indicate whether the prediction block is determined by filtering the selected reference block rᵢ.

At 1632, the system may determine whether the intraTMP predictor is determined by filtering a selected reference block based on the sixth syntax element. For example, if the current block is predicted by intraTMP but not by intraTMP fusion (intra_tmp_fusion_flag is 0), then along with the intraTMP index an intraTMP filter flag (intra_tmp_filter_flag) is signaled to indicate whether the prediction block is determined by filtering the selected reference block rᵢ.

At 1634, the system may, in response to the sixth syntax element including a first value, determine the intraTMP predictor by filtering the selected reference block with a learned filter. For example, when intra_tmp_filter_flag is 1, the prediction block is determined by filtering with a learned filter c, according to equation (13). The learned filter c in equation (13) may be determined by equation (14).

At 1636, the system may, in response to the sixth syntax element including a second value, encode a seventh syntax element to the bitstream. For example, if the current block is predicted by intraTMP, but not by intraTMP fusion and not by intraTMP filtering (intra_tmp_filter_flag is 0), then an intraTMP sub-pixel flag (intra_tmp_sub_pel_flag) may be signaled to indicate whether the intraTMP BV is further refined with fractional precision.

At 1638, the system may determine whether the block vector is refined with factional precision based on the seventh syntax element. For example, if the current block is predicted by intraTMP, but not by intraTMP fusion and not by intraTMP filtering (intra_tmp_filter_flag is 0), then an intraTMP sub-pixel flag (intra_tmp_sub_pel_flag) may be signaled to indicate whether the intraTMP BV is further refined with fractional precision.

At 1640, the system may, in response to the seventh syntax element including a first value, determining, by the processor, the block vector is not refined with fractional precision.

At 1642, the system may, in response to the seventh syntax element including a second value, determine the block vector is refined with fractional precision. For example, if intra_tmp_sub_pel_flag is 0, then the intraTMP block vector is not further modified. Then, the prediction block is the selected reference block rᵢ.

Referring to FIG. 16D, at 1644, the system may, in response to the seventh syntax element including the second value, encode an eighth syntax element and a ninth syntax element to the bitstream. For example, if intra_tmp_sub_pel_flag is 1, then the intraTMP BV is further refined by signaling a sub-pixel refinement direction (intra_tmp_sub_pel_direction_idx) and a sub-pixel refinement phase (intra_tmp_sub_pel_phase_idx).

At 1646, the system may determine a sub-pixel refinement direction based on the eighth syntax element. For example, the sub-pixel refinement may proceed in one of 8 directions as shown in FIG. 14 by arrows. intra_tmp_sub_pel_direction_idx signals the sub-pixel refinement direction by taking a value in the range 0 to 7, signaled as a 3-bit fixed length code.

At 1648, the system may determine a sub-pixel refinement phase based on the nineth syntax element. For example, the distance the sub-pixel refined BV is from bvᵢ is signaled by intra_tmp_sub_pel_phase_idx, which signals the value 0 to indicate a phase of ¼, the value 1 to indicate a phase of ½, and the value 2 to indicate a phase of ¾.

At 1650, the system may refine the block vector based on the sub-pixel refinement direction and the sub-pixel refinement phase. For example, the prediction block with sub-pixel refinement is determined by applying 1-dimensional interpolation filters in a separable manner, with ¼, ½, or ¾ phase interpolation filters used to achieve the desired interpolation. The interpolation filters may be re-used from existing interpolation filters used in ECM for motion compensation, or existing ECM filters used for intra reference sample interpolation, or they may be interpolation filters specifically designed for intraTMP.

At 1652, the system may encode the current block based on the intraTMP predictor. For example, encoder 101 may encode the current block based on the intraTMP predictor determined based on the various syntax elements parsed to the bitstream as described above.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of decoding by a decoder is provided. The method may include parsing, by a processor, a bitstream to decode a plurality of syntax elements associated with intraTMP. The method may include decoding, by the processor, a first syntax element from the bitstream. The method may include determining, by the processor, whether an intraTMP mode is enabled for a current block based on the first syntax element. The method may include, in response to the intraTMP mode being enabled for the current block, decoding, by the processor, a second syntax element from the bitstream. The method may include determining, by the processor, whether an intraTMP predictor for the current block is determined by an intraTMP fusion mode based on the second syntax element. The method may include, in response to determining the intraTMP predictor is determined by an intraTMP fusion mode, decoding, by the processor, a third syntax element and a fourth syntax element from the bitstream. The method may include determining, by the processor, a set of fusion weights based on the fourth syntax element. The method may include determining, by the processor, the intraTMP predictor based on the set of fusion weights and a set of reference blocks indicated by the third syntax element. The method may include decoding, by the processor, the current block based on the intraTMP predictor.

In some implementations, in response to the determining the intraTMP predictor for the current block is determined by the intraTMP fusion mode, the method may include performing, by the processor, a sparse search and a refinement search to construct a candidate list of N intraTMP block vectors by selecting block vectors according to an SAD cost calculated over a template area.

In some implementations, the performing, by the processor, the sparse search and the refinement search to construct the candidate list of N intraTMP block vectors by selecting the block vectors according to the SAD cost calculated over the template area may include identifying, by the processor, a set of sparse-candidate block vectors in parallel during the sparse search. In some implementations, the performing, by the processor, the sparse search and the refinement search to construct the candidate list of N intraTMP block vectors by selecting the block vectors according to the SAD cost calculated over the template area may include constructing, by the processor, the candidate list of N intraTMP block vectors searching around the sparse-candidate block vectors using a selected template shape.

In some implementations, the method may include determining, by the processor, the set of reference blocks selected for determining the intraTMP predictor based on the third syntax element.

In some implementations, in response to the fourth syntax element including a first value, the method may include determining, by the processor, the set of fusion weights using a SAD-based algorithm. In some implementations, in response to the fourth syntax element including a second value, the method may include determining, by the processor, the set of fusion weights using an MSE-based algorithm.

In some implementations, in response to the second syntax element indicating intraTMP fusion is not enabled for the current block, the method may include decoding, by the processor, a fifth syntax element from the bitstream. In some implementations, the method may include identifying, by the processor, a block vector from the candidate list based on the fifth syntax element.

In some implementations, the fifth syntax element has a value from 0 to 18. In some implementations, when the fifth syntax element has a value in a range from 3 to 18, the fifth syntax element is signaled in the bitstream by a 0 followed by intra_tmp_idx−2 expressed as a 4-bit fixed length code.

In some implementations, in response to the second syntax element indicating intraTMP fusion is not enabled for the current block, the method may include decoding, by the processor, a sixth syntax element from the bitstream. In some implementations, determining, by the processor, whether the intraTMP predictor is determined by filtering a selected reference block based on the sixth syntax element.

In some implementations, in response to the sixth syntax element including a first value, the method may include determining, by the processor, the intraTMP predictor by filtering the selected reference block with a learned filter.

In some implementations, in response to the sixth syntax element including a second value, the method may include decoding, by the processor, a seventh syntax element from the bitstream. In some implementations, the method may include determining, by the processor, whether the block vector is refined with factional precision based on the seventh syntax element.

In some implementations, in response to the seventh syntax element including a first value, the method may include determining, by the processor, the block vector is not refined with fractional precision. In some implementations, in response to the seventh syntax element including a second value, the method may include determining, by the processor, the block vector is refined with fractional precision.

In some implementations, in response to the seventh syntax element including the second value, the method may include decoding, by the processor, an eighth syntax element and a ninth syntax element from the bitstream. In some implementations, the method may include determining, by the processor, a sub-pixel refinement direction based on the eighth syntax element. In some implementations, the method may include determining, by the processor, a sub-pixel refinement phase based on the ninth syntax element. In some implementations, the method may include refining, by the processor, the block vector based on the sub-pixel refinement direction and the sub-pixel refinement phase.

According to another aspect of the present disclosure, a decoder is provided. The decoder may include a processor and memory storing instructions. The memory storing instructions, which when executed by the processor, may cause the processor to parse a bitstream to decode a plurality of syntax elements associated with intraTMP. The memory storing instructions, which when executed by the processor, may cause the processor to decode a first syntax element from the bitstream. The memory storing instructions, which when executed by the processor, may cause the processor to determine whether an intraTMP mode is enabled for a current block based on the first syntax element. The memory storing instructions, which when executed by the processor, may cause the processor to, in response to the intraTMP mode being enabled for the current block, decode a second syntax element from the bitstream. The memory storing instructions, which when executed by the processor, may cause the processor to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, decode a third syntax element and a fourth syntax element from the bitstream. The memory storing instructions, which when executed by the processor, may cause the processor to determine a set of fusion weights based on the fourth syntax element. The memory storing instructions, which when executed by the processor, may cause the processor to determine the intraTMP predictor based on the set of fusion weights and a set of reference blocks indicated by the third syntax element. The memory storing instructions, which when executed by the processor, may cause the processor to decode the current block based on the intraTMP predictor.

In some implementations, the memory storing instructions, which when executed by the processor, may further cause the processor to, in response to the determining the intraTMP predictor for the current block is determined by the intraTMP fusion mode, perform a sparse search and a refinement search to construct a candidate list of N intraTMP block vectors by selecting block vectors according to a SAD cost calculated over a template area.

In some implementations, to perform the sparse search and the refinement search to construct the candidate list of N intraTMP block vectors by selecting the block vectors according to the SAD cost calculated over the template area, the the memory storing instructions, which when executed by the processor, further cause the processor to identify a set of sparse-candidate block vectors in parallel during the sparse search. In some implementations, to perform the sparse search and the refinement search to construct the candidate list of N intraTMP block vectors by selecting the block vectors according to the SAD cost calculated over the template area, the the memory storing instructions, which when executed by the processor, further cause the processor to construct the candidate list of N intraTMP block vectors searching around the sparse-candidate block vectors using a selected template shape.

In some implementations, the memory storing instructions, which when executed by the processor, further cause the processor to determine the set of reference blocks selected for determining the intraTMP predictor based on the third syntax element.

In some implementations, the memory storing instructions, which when executed by the processor, may further cause the processor to, in response to the fourth syntax element including a first value, determine the set of fusion weights using an SAD-based algorithm. In some implementations, the memory storing instructions, which when executed by the processor, may further cause the processor to, in response to the fourth syntax element including a second value, determine the set of fusion weights using an MSE-based algorithm.

In some implementations, the memory storing instructions, which when executed by the processor, may further cause the processor to, in response to the second syntax element indicating intraTMP fusion is not enabled for the current block, decode a fifth syntax element from the bitstream. In some implementations, the memory storing instructions, which when executed by the processor, may further cause the processor to identify a block vector from the candidate list based on the fifth syntax element.

In some implementations, the fifth syntax element has a value from 0 to 18. In some implementations, when the fifth syntax element has a value in a range from 3 to 18, the fifth syntax element is signaled in the bitstream by a 0 followed by intra_tmp_idx−2 expressed as a 4-bit fixed length code.

In some implementations, the memory storing instructions, which when executed by the processor, may further cause the processor to, in response to the second syntax element indicating intraTMP fusion is not enabled for the current block, decode a sixth syntax element from the bitstream. In some implementations, the memory storing instructions, which when executed by the processor, may further cause the processor to determine whether the intraTMP predictor is determined by filtering a selected reference block based on the sixth syntax element.

In some implementations, the memory storing instructions, which when executed by the processor, may further cause the processor to, in response to the sixth syntax element including a first value, determine the intraTMP predictor by filtering the selected reference block with a learned filter.

In some implementations, the memory storing instructions, which when executed by the processor, may further cause the processor to, in response to the sixth syntax element including a second value, decode a seventh syntax element from the bitstream. In some implementations, the memory storing instructions, which when executed by the processor, may further cause the processor to determine whether the block vector is refined with factional precision based on the seventh syntax element.

In some implementations, the memory storing instructions, which when executed by the processor, may further cause the processor to, in response to the seventh syntax element including a first value, determine the block vector is not refined with fractional precision. In some implementations, the memory storing instructions, which when executed by the processor, may further cause the processor to, in response to the seventh syntax element including a second value, determine the block vector is refined with fractional precision.

In some implementations, the memory storing instructions, which when executed by the processor, may further cause the processor to, in response to the seventh syntax element including the second value, decode an eighth syntax element and a ninth syntax element from the bitstream. In some implementations, the memory storing instructions, which when executed by the processor, may further cause the processor to determine a sub-pixel refinement direction based on the eighth syntax element. In some implementations, the memory storing instructions, which when executed by the processor, may further cause the processor to determine a sub-pixel refinement phase based on the ninth syntax element. In some implementations, the memory storing instructions, which when executed by the processor, may further cause the processor to refine the block vector based on the sub-pixel refinement direction and the sub-pixel refinement phase.

According to a further aspect of the present disclosure, a non-transitory computer-readable medium storing instructions for a decoder is provided. The memory storing instructions, which when executed by the processor of the decoder, may cause the processor of the decoder to parse a bitstream to decode a plurality of syntax elements associated with intraTMP. The memory storing instructions, which when executed by the processor of the decoder, may cause the processor of the decoder to decode a first syntax element from the bitstream. The memory storing instructions, which when executed by the processor of the decoder, may cause the processor of the decoder to determine whether an intraTMP mode is enabled for a current block based on the first syntax element. The memory storing instructions, which when executed by the processor, may cause the processor to, in response to the intraTMP mode being enabled for the current block, decode a second syntax element from the bitstream. The memory storing instructions, which when executed by the processor of the decoder, may cause the processor of the decoder to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, decode a third syntax element and a fourth syntax element from the bitstream. The memory storing instructions, which when executed by the processor of the decoder, may cause the processor of the decoder to determine a set of fusion weights based on the fourth syntax element. The memory storing instructions, which when executed by the processor of the decoder, may cause the processor of the decoder to determine the intraTMP predictor based on the set of fusion weights and a set of reference blocks indicated by the third syntax element. The memory storing instructions, which when executed by the processor of the decoder, may cause the processor of the decoder to decode the current block based on the intraTMP predictor.

In some implementations, the memory storing instructions, which when executed by the processor of the decoder, may further cause the processor of the decoder to, in response to the determining the intraTMP predictor for the current block is determined by the intraTMP fusion mode, perform a sparse search and a refinement search to construct a candidate list of N intraTMP block vectors by selecting block vectors according to a SAD cost calculated over a template area.

In some implementations, to perform the sparse search and the refinement search to construct the candidate list of N intraTMP block vectors by selecting the block vectors according to the SAD cost calculated over the template area, the the memory storing instructions, which when executed by the processor, further cause the processor to identify a set of sparse-candidate block vectors in parallel during the sparse search. In some implementations, to perform the sparse search and the refinement search to construct the candidate list of N intraTMP block vectors by selecting the block vectors according to the SAD cost calculated over the template area, the the memory storing instructions, which when executed by the processor, further cause the processor to construct the candidate list of N intraTMP block vectors searching around the sparse-candidate block vectors using a selected template shape.

In some implementations, the memory storing instructions, which when executed by the processor, further cause the processor to determine the set of reference blocks selected for determining the intraTMP predictor based on the third syntax element.

In some implementations, the memory storing instructions, which when executed by the processor of the decoder, may further cause the processor of the decoder to, in response to the fourth syntax element including a first value, determine the set of fusion weights using a SAD-based algorithm. In some implementations, the memory storing instructions, which when executed by the processor of the decoder, may further cause the processor of the decoder to, in response to the fourth syntax element including a second value, determine the set of fusion weights using an MSE-based algorithm.

In some implementations, the memory storing instructions, which when executed by the processor of the decoder, may further cause the processor of the decoder to, in response to the second syntax element indicating intraTMP fusion is not enabled for the current block, decode a fifth syntax element from the bitstream. In some implementations, the memory storing instructions, which when executed by the processor of the decoder, may further cause the processor of the decoder to identify a block vector from the candidate list based on the fifth syntax element.

In some implementations, the fifth syntax element has a value from 0 to 18. In some implementations, when the fifth syntax element has a value in a range from 3 to 18, the fifth syntax element is signaled in the bitstream by a 0 followed by intra_tmp_idx−2 expressed as a 4-bit fixed length code.

In some implementations, the memory storing instructions, which when executed by the processor of the decoder, may further cause the processor of the decoder to, in response to the second syntax element indicating intraTMP fusion is not enabled for the current block, decode a sixth syntax element from the bitstream. In some implementations, the memory storing instructions, which when executed by the processor of the decoder, may further cause the processor of the decoder to determine whether the intraTMP predictor is determined by filtering a selected reference block based on the sixth syntax element.

In some implementations, the memory storing instructions, which when executed by the processor of the decoder, may further cause the processor of the decoder to, in response to the sixth syntax element including a first value, determine the intraTMP predictor by filtering the selected reference block with a learned filter.

In some implementations, the memory storing instructions, which when executed by the processor of the decoder, may further cause the processor of the decoder to, in response to the sixth syntax element including a second value, decode a seventh syntax element from the bitstream. In some implementations, the memory storing instructions, which when executed by the processor of the decoder, may further cause the processor of the decoder to determine whether the block vector is refined with factional precision based on the seventh syntax element.

In some implementations, the memory storing instructions, which when executed by the processor of the decoder, may further cause the processor of the decoder to, in response to the seventh syntax element including a first value, determine the block vector is not refined with fractional precision. In some implementations, the memory storing instructions, which when executed by the processor of the decoder, may further cause the processor of the decoder to, in response to the seventh syntax element including a second value, determine the block vector is refined with fractional precision.

In some implementations, the memory storing instructions, which when executed by the processor of the decoder, may further cause the processor of the decoder to, in response to the seventh syntax element including the second value, decode an eighth syntax element and a ninth syntax element from the bitstream. In some implementations, the memory storing instructions, which when executed by the processor of the decoder, may further cause the processor of the decoder to determine a sub-pixel refinement direction based on the eighth syntax element. In some implementations, the memory storing instructions, which when executed by the processor of the decoder, may further cause the processor of the decoder to determine a sub-pixel refinement phase based on the ninth syntax element. In some implementations, the memory storing instructions, which when executed by the processor of the decoder, may further cause the processor of the decoder to refine the block vector based on the sub-pixel refinement direction and the sub-pixel refinement phase.

According to yet another aspect of the present disclosure, a method of encoding by an encoder is provided. The method may include enabling, by a processor, intraTMP to encode a current block. The method may include encoding, by the processor, a first syntax element to a bitstream. The method may include determining, by the processor, whether an intraTMP mode is enabled for a current block based on the first syntax element. The method may include, in response to the intraTMP mode being enabled for the current block, encoding, by the processor, a second syntax element to the bitstream. The method may include determining, by the processor, whether an intraTMP predictor for the current block is determined by an intraTMP fusion mode based on the second syntax element. The method may include, in response to determining the intraTMP predictor is determined by an intraTMP fusion mode, encoding, by the processor, a third syntax element and a fourth syntax element to the bitstream. The method may include determining, by the processor, a set of fusion weights based on the fourth syntax element. The method may include determining, by the processor, the intraTMP predictor based on the set of fusion weights and a set of reference blocks indicated by the third syntax element. The method may include encoding, by the processor, the current block based on the intraTMP predictor.

In some implementations, in response to the determining the intraTMP predictor for the current block is determined by the intraTMP fusion mode, the method may include performing, by the processor, a sparse search and a refinement search to construct a candidate list of N intraTMP block vectors by selecting block vectors according to an SAD cost calculated over a template area.

In some implementations, the performing, by the processor, the sparse search and the refinement search to construct the candidate list of N intraTMP block vectors by selecting the block vectors according to the SAD cost calculated over the template area may include identifying, by the processor, a set of sparse-candidate block vectors in parallel during the sparse search. In some implementations, the performing, by the processor, the sparse search and the refinement search to construct the candidate list of N intraTMP block vectors by selecting the block vectors according to the SAD cost calculated over the template area may include constructing, by the processor, the candidate list of N intraTMP block vectors searching around the sparse-candidate block vectors using a selected template shape.

In some implementations, the method may include determining, by the processor, the set of reference blocks selected for determining the intraTMP predictor based on the third syntax element.

In some implementations, in response to the fourth syntax element including a first value, the method may include determining, by the processor, the set of fusion weights using an SAD-based algorithm. In some implementations, in response to the fourth syntax element including a second value, the method may include determining, by the processor, the set of fusion weights using an MSE-based algorithm.

In some implementations, in response to the second syntax element indicating intraTMP fusion is not enabled for the current block, the method may include encoding, by the processor, a fifth syntax element to the bitstream. In some implementations, the method may include identifying, by the processor, a block vector from the candidate list based on the fifth syntax element.

In some implementations, the fifth syntax element has a value from 0 to 18. In some implementations, when the fifth syntax element has a value in a range from 3 to 18, the fifth syntax element is signaled in the bitstream by a 0 followed by intra_tmp_idx−2 expressed as a 4-bit fixed length code.

In some implementations, in response to the second syntax element indicating intraTMP fusion is not enabled for the current block, the method may include encoding, by the processor, a sixth syntax element to the bitstream. In some implementations, the method may include determining, by the processor, whether the intraTMP predictor is determined by filtering a selected reference block based on the sixth syntax element.

In some implementations, in response to the sixth syntax element including a first value, the method may include determining, by the processor, the intraTMP predictor by filtering the selected reference block with a learned filter.

In some implementations, in response to the sixth syntax element including a second value, the method may include encoding, by the processor, a seventh syntax element to the bitstream. In some implementations, the method may include determining, by the processor, whether the block vector is refined with factional precision based on the seventh syntax element.

In some implementations, in response to the seventh syntax element including a first value, the method may include determining, by the processor, the block vector is not refined with fractional precision. In some implementations, in response to the seventh syntax element including a second value, the method may include determining, by the processor, the block vector is refined with fractional precision.

In some implementations, in response to the seventh syntax element including the second value, the method may include encoding, by the processor, an eighth syntax element and a ninth syntax element to the bitstream. In some implementations, the method may include determining, by the processor, a sub-pixel refinement direction based on the eighth syntax element. In some implementations, the method may include determining, by the processor, a sub-pixel refinement phase based on the ninth syntax element. In some implementations, the method may include refining, by the processor, the block vector based on the sub-pixel refinement direction and the sub-pixel refinement phase.

According to still another aspect of the present disclosure, an encoder is provided. The encoder may include a processor and memory storing instructions. The memory storing instructions, which when executed by the processor, may cause the processor to enable intraTMP to encode a current block. The memory storing instructions, which when executed by the processor, may cause the processor to encode a first syntax element to a bitstream. The memory storing instructions, which when executed by the processor, may cause the processor to determine whether an intraTMP mode is enabled for a current block based on the first syntax element. The memory storing instructions, which when executed by the processor, may cause the processor to, in response to the intraTMP mode being enabled for the current block, encode a second syntax element to the bitstream. The memory storing instructions, which when executed by the processor, may cause the processor to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, encode a third syntax element and a fourth syntax element to the bitstream. The memory storing instructions, which when executed by the processor, may cause the processor to determine a set of fusion weights based on the fourth syntax element. The memory storing instructions, which when executed by the processor, may cause the processor to determine the intraTMP predictor based on the set of fusion weights and a set of reference blocks indicated by the third syntax element. The memory storing instructions, which when executed by the processor, may cause the processor to encode the current block based on the intraTMP predictor.

In some implementations, the memory storing instructions, which when executed by the processor, may cause the processor to, in response to the determining the intraTMP predictor for the current block is determined by the intraTMP fusion mode, perform a sparse search and a refinement search to construct a candidate list of N intraTMP block vectors by selecting block vectors according to an SAD cost calculated over a template area.

In some implementations, to perform the sparse search and the refinement search to construct the candidate list of N intraTMP block vectors by selecting the block vectors according to the SAD cost calculated over the template area, the memory storing instructions, which when executed by the processor, may cause the processor to identify a set of sparse-candidate block vectors in parallel during the sparse search. In some implementations, to perform the sparse search and the refinement search to construct the candidate list of N intraTMP block vectors by selecting the block vectors according to the SAD cost calculated over the template area, the memory storing instructions, which when executed by the processor, may cause the processor to construct the candidate list of N intraTMP block vectors searching around the sparse-candidate block vectors using a selected template shape.

In some implementations, the memory storing instructions, which when executed by the processor, may cause the processor to determine the set of reference blocks selected for determining the intraTMP predictor based on the third syntax element.

In some implementations, the memory storing instructions, which when executed by the processor, may cause the processor to, in response to the fourth syntax element including a first value, determine the set of fusion weights using an SAD-based algorithm. In some implementations, the memory storing instructions, which when executed by the processor, may cause the processor to, in response to the fourth syntax element including a second value, determine the set of fusion weights using an MSE-based algorithm.

In some implementations, the memory storing instructions, which when executed by the processor, may cause the processor to, in response to the second syntax element indicating intraTMP fusion is not enabled for the current block, encode a fifth syntax element to the bitstream. In some implementations, the memory storing instructions, which when executed by the processor, may cause the processor to identify a block vector from the candidate list based on the fifth syntax element.

In some implementations, the fifth syntax element has a value from 0 to 18. In some implementations, when the fifth syntax element has a value in a range from 3 to 18, the fifth syntax element is signaled in the bitstream by a 0 followed by intra_tmp_idx−2 expressed as a 4-bit fixed length code.

In some implementations, the memory storing instructions, which when executed by the processor, may cause the processor to, in response to the second syntax element indicating intraTMP fusion is not enabled for the current block, encode a sixth syntax element to the bitstream. In some implementations, the memory storing instructions, which when executed by the processor, may cause the processor to determine whether the intraTMP predictor is determined by filtering a selected reference block based on the sixth syntax element.

In some implementations, the memory storing instructions, which when executed by the processor, may cause the processor to, in response to the sixth syntax element including a first value, determine the intraTMP predictor by filtering the selected reference block with a learned filter.

In some implementations, the memory storing instructions, which when executed by the processor, may cause the processor to, in response to the sixth syntax element including a second value, encode a seventh syntax element to the bitstream. In some implementations, the memory storing instructions, which when executed by the processor, may cause the processor to determine whether the block vector is refined with factional precision based on the seventh syntax element.

In some implementations, the memory storing instructions, which when executed by the processor, may cause the processor to, in response to the seventh syntax element including a first value, determine the block vector is not refined with fractional precision. In some implementations, the memory storing instructions, which when executed by the processor, may cause the processor to, in response to the seventh syntax element including a second value, determine the block vector is refined with fractional precision.

In some implementations, the memory storing instructions, which when executed by the processor, may cause the processor to, in response to the seventh syntax element including the second value, encode an eighth syntax element and a ninth syntax element to the bitstream. In some implementations, the memory storing instructions, which when executed by the processor, may cause the processor to determine a sub-pixel refinement direction based on the eighth syntax element. In some implementations, the memory storing instructions, which when executed by the processor, may cause the processor to determine a sub-pixel refinement phase based on the ninth syntax element. In some implementations, the memory storing instructions, which when executed by the processor, may cause the processor to refine the block vector based on the sub-pixel refinement direction and the sub-pixel refinement phase.

According to still a further aspect of the present disclosure, a non-transitory computer-readable medium storing instructions for an encoder is provided. The instructions, which when executed by the processor of the encoder, may cause the processor of the encoder to enable intraTMP to encode a current block. The instructions, which when executed by the processor of the encoder, may cause the processor of the encoder to encode a first syntax element to a bitstream. The instructions, which when executed by the processor of the encoder, may cause the processor of the encoder to determine whether an intraTMP mode is enabled for a current block based on the first syntax element. The memory storing instructions, which when executed by the processor, may cause the processor to, in response to the intraTMP mode being enabled for the current block, encode a second syntax element to the bitstream. The instructions, which when executed by the processor of the encoder, may cause the processor of the encoder to determine whether an intraTMP predictor for the current block is determined by an intraTMP fusion mode based on the second syntax element. The memory storing instructions, which when executed by the processor, may cause the processor to, in response to determining the intraTMP predictor is determined by an intraTMP fusion mode, encode a third syntax element and a fourth syntax element to the bitstream. The instructions, which when executed by the processor of the encoder, may cause the processor of the encoder to determine a set of fusion weights based on the fourth syntax element. The instructions, which when executed by the processor of the encoder, may cause the processor of the encoder to determine the intraTMP predictor based on the set of fusion weights and a set of reference blocks indicated by the third syntax element. The instructions, which when executed by the processor of the encoder, may cause the processor of the encoder to encode the current block based on the intraTMP predictor.

In some implementations, the instructions, which when executed by the processor of the encoder, may cause the processor of the encoder to, in response to the determining the intraTMP predictor for the current block is determined by the intraTMP fusion mode, perform a sparse search and a refinement search to construct a candidate list of N intraTMP block vectors by selecting block vectors according to an SAD cost calculated over a template area.

In some implementations, to perform the sparse search and the refinement search to construct the candidate list of N intraTMP block vectors by selecting the block vectors according to the SAD cost calculated over the template area, the instructions, which when executed by the processor of the encoder, may cause the processor of the encoder to identify a set of sparse-candidate block vectors in parallel during the sparse search. In some implementations, to perform the sparse search and the refinement search to construct the candidate list of N intraTMP block vectors by selecting the block vectors according to the SAD cost calculated over the template area, the instructions, which when executed by the processor of the encoder, may cause the processor of the encoder to construct the candidate list of N intraTMP block vectors searching around the sparse-candidate block vectors using a selected template shape.

In some implementations, the instructions, which when executed by the processor of the encoder, may cause the processor of the encoder to determine the set of reference blocks selected for determining the intraTMP predictor based on the third syntax element.

In some implementations, the instructions, which when executed by the processor of the encoder, may cause the processor of the encoder to, in response to the fourth syntax element including a first value, determine the set of fusion weights using an SAD-based algorithm. In some implementations, the instructions, which when executed by the processor of the encoder, may cause the processor of the encoder to, in response to the fourth syntax element including a second value, determine the set of fusion weights using an MSE-based algorithm.

In some implementations, the instructions, which when executed by the processor of the encoder, may cause the processor of the encoder to, in response to the second syntax element indicating intraTMP fusion is not enabled for the current block, encode a fifth syntax element to the bitstream. In some implementations, the instructions, which when executed by the processor of the encoder, may cause the processor of the encoder to identify a block vector from the candidate list based on the fifth syntax element.

In some implementations, the fifth syntax element has a value from 0 to 18. In some implementations, when the fifth syntax element has a value in a range from 3 to 18, the fifth syntax element is signaled in the bitstream by a 0 followed by intra_tmp_idx−2 expressed as a 4-bit fixed length code.

In some implementations, the instructions, which when executed by the processor of the encoder, may cause the processor of the encoder to, in response to the second syntax element indicating intraTMP fusion is not enabled for the current block, encode a sixth syntax element to the bitstream. In some implementations, the instructions, which when executed by the processor of the encoder, may cause the processor of the encoder to determine whether the intraTMP predictor is determined by filtering a selected reference block based on the sixth syntax element.

In some implementations, the instructions, which when executed by the processor of the encoder, may cause the processor of the encoder to, in response to the sixth syntax element including a first value, determine the intraTMP predictor by filtering the selected reference block with a learned filter.

In some implementations, the instructions, which when executed by the processor of the encoder, may cause the processor of the encoder to, in response to the sixth syntax element including a second value, encode a seventh syntax element to the bitstream. In some implementations, the instructions, which when executed by the processor of the encoder, may cause the processor of the encoder to determine whether the block vector is refined with factional precision based on the seventh syntax element.

In some implementations, the instructions, which when executed by the processor of the encoder, may cause the processor of the encoder to, in response to the seventh syntax element including a first value, determine the block vector is not refined with fractional precision. In some implementations, the instructions, which when executed by the processor of the encoder, may cause the processor of the encoder to, in response to the seventh syntax element including a second value, determine the block vector is refined with fractional precision.

In some implementations, the instructions, which when executed by the processor of the encoder, may cause the processor of the encoder to, in response to the seventh syntax element including the second value, encode an eighth syntax element and a ninth syntax element to the bitstream. In some implementations, the instructions, which when executed by the processor of the encoder, may cause the processor of the encoder to determine a sub-pixel refinement direction based on the eighth syntax element. In some implementations, the instructions, which when executed by the processor of the encoder, may cause the processor of the encoder to determine a sub-pixel refinement phase based on the ninth syntax element. In some implementations, the instructions, which when executed by the processor of the encoder, may cause the processor of the encoder to refine the block vector based on the sub-pixel refinement direction and the sub-pixel refinement phase.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of decoding by a decoder, comprising:
decoding, by a processor, a first syntax element from a bitstream;
determining, by the processor, whether an intra template prediction (intraTMP) mode is enabled for a current block based on the first syntax element;
in response to the intraTMP mode being enabled for the current block, decoding, by the processor, a second syntax element from the bitstream;
determining, by the processor, whether an intraTMP predictor for the current block is determined by an intraTMP fusion mode based on the second syntax element;
in response to determining the intraTMP predictor is determined by an intraTMP fusion mode, decoding, by the processor, a third syntax element and a fourth syntax element from the bitstream;
determining, by the processor, a set of fusion weights based on the fourth syntax element;
determining, by the processor, the intraTMP predictor based on the set of fusion weights and a set of reference blocks indicated by the third syntax element; and
decoding, by the processor, the current block based on the intraTMP predictor.

2. The method of claim 1, further comprising:
in response to the determining the intraTMP predictor for the current block is determined by the intraTMP fusion mode, performing, by the processor, a sparse search and a refinement search to construct a candidate list of N intraTMP block vectors by selecting block vectors according to a sum-of-absolute-differences (SAD) cost calculated over a template area.

3. The method of claim 2, wherein the performing, by the processor, the sparse search and the refinement search to construct the candidate list of N intraTMP block vectors by selecting the block vectors according to the SAD cost calculated over the template area comprises:
identifying, by the processor, a set of sparse-candidate block vectors in parallel during the sparse search; and
constructing, by the processor, the candidate list of N intraTMP block vectors searching around the sparse-candidate block vectors using a selected template shape.

4. The method of claim 1, further comprising:
determining, by the processor, the set of reference blocks selected for determining the intraTMP predictor based on the third syntax element.

5. The method of claim 1, further comprising:
in response to the fourth syntax element including a first value, determining, by the processor, the set of fusion weights using a sum-of-absolute-differences (SAD)-based algorithm; and
in response to the fourth syntax element including a second value, determining, by the processor, the set of fusion weights using a mean-square error (MSE)-based algorithm.

6. The method of claim 2, further comprising:
in response to the second syntax element indicating intraTMP fusion is not enabled for the current block, decoding, by the processor, a fifth syntax element from the bitstream; and
identifying, by the processor, a block vector from the candidate list based on the fifth syntax element.

7. The method of claim 6, wherein:
the fifth syntax element has a value from 0 to 18, and
when the fifth syntax element has a value in a range from 3 to 18, the fifth syntax element is signaled in the bitstream by a 0 followed by intra_tmp_idx−2 expressed as a 4-bit fixed length code.

8. The method of claim 6, further comprising:
in response to the second syntax element indicating intraTMP fusion is not enabled for the current block, decoding, by the processor, a sixth syntax element from the bitstream; and
determining, by the processor, whether the intraTMP predictor is determined by filtering a selected reference block based on the sixth syntax element.

9. The method of claim 8, further comprising:
in response to the sixth syntax element including a first value, determining, by the processor, the intraTMP predictor by filtering the selected reference block with a learned filter.

10. The method of claim 9, further comprising:
in response to the sixth syntax element including a second value, decoding, by the processor, a seventh syntax element from the bitstream; and
determining, by the processor, whether the block vector is refined with factional precision based on the seventh syntax element.

11. The method of claim 10, further comprising:
in response to the seventh syntax element including a first value, determining, by the processor, the block vector is not refined with fractional precision; and
in response to the seventh syntax element including a second value, determining, by the processor, the block vector is refined with fractional precision.

12. The method of claim 11, further comprising:
in response to the seventh syntax element including the second value, decoding, by the processor, an eighth syntax element and a nineth syntax element from the bitstream;
determining, by the processor, a sub-pixel refinement direction based on the eighth syntax element;
determining, by the processor, a sub-pixel refinement phase based on the ninth syntax element; and
refining, by the processor, the block vector based on the sub-pixel refinement direction and the sub-pixel refinement phase.

13. A method of encoding by an encoder, comprising:
enabling, by a processor, intra template prediction (intraTMP) to encode a current block;
encoding, by the processor, a first syntax element to a bitstream;
determining, by the processor, whether an intraTMP mode is enabled for a current block based on the first syntax element;
in response to the intraTMP mode being enabled for the current block, encoding, by the processor, a second syntax element to the bitstream;
determining, by the processor, whether an intraTMP predictor for the current block is determined by an intraTMP fusion mode based on the second syntax element;
in response to determining the intraTMP predictor is determined by an intraTMP fusion mode, encoding, by the processor, a third syntax element and a fourth syntax element to the bitstream;
determining, by the processor, a set of fusion weights based on the fourth syntax element;
determining, by the processor, the intraTMP predictor based on the set of fusion weights and a set of reference blocks indicated by the third syntax element; and
encoding, by the processor, the current block based on the intraTMP predictor.

14. The method of claim 13, further comprising:
in response to the determining the intraTMP predictor for the current block is determined by the intraTMP fusion mode, performing, by the processor, a sparse search and a refinement search to construct a candidate list of N intraTMP block vectors by selecting block vectors according to a sum-of-absolute-differences (SAD) cost calculated over a template area.

15. The method of claim 13, further comprising:
determining, by the processor, the set of reference blocks selected for determining the intraTMP predictor based on the third syntax element.

16. The method of claim 13, further comprising:
in response to the fourth syntax element including a first value, determining, by the processor, the set of fusion weights using a sum-of-absolute-differences (SAD)-based algorithm; and
in response to the fourth syntax element including a second value, determining, by the processor, the set of fusion weights using a mean-square error (MSE)-based algorithm.

17. The method of claim 14, further comprising:
in response to the second syntax element indicating intraTMP fusion is not enabled for the current block, encoding, by the processor, a fifth syntax element to the bitstream; and
identifying, by the processor, a block vector from the candidate list based on the fifth syntax element.

18. The method of claim 17, further comprising:
in response to the second syntax element indicating intraTMP fusion is not enabled for the current block, encoding, by the processor, a sixth syntax element to the bitstream; and
determining, by the processor, whether the intraTMP predictor is determined by filtering a selected reference block based on the sixth syntax element.

19. The method of claim 18, further comprising:
in response to the sixth syntax element including a second value, encoding, by the processor, a seventh syntax element to the bitstream; and
determining, by the processor, whether the block vector is refined with factional precision based on the seventh syntax element.

20. A non-transitory computer-readable medium storing a bitstream, wherein the bitstream is generated by performing an encoding method comprising:
enabling intra template prediction (intraTMP) to encode a current block;
encoding a first syntax element to a bitstream;
determining whether an intraTMP mode is enabled for a current block based on the first syntax element;
in response to the intraTMP mode being enabled for the current block, encoding a second syntax element to the bitstream;
determining whether an intraTMP predictor for the current block is determined by an intraTMP fusion mode based on the second syntax element;
in response to determining the intraTMP predictor is determined by an intraTMP fusion mode, encoding a third syntax element and a fourth syntax element to the bitstream;
determining a set of fusion weights based on the fourth syntax element;
determining the intraTMP predictor based on the set of fusion weights and a set of reference blocks indicated by the third syntax element; and
encoding the current block based on the intraTMP predictor.
